(19) United States
(12) Patent Application Publication
(10) Pub. No.: US 2017/0262559 A1
(43) Pub. Date: Sep. 14, 2017

(54) Methods and Systems for Simulating Nanoparticle Flux

(71) Applicant: The Board of Trustees of the Leland Stanford Junior University, Stanford, CA (US)

(72) Inventors: Eric S. Shaqfeh, Stanford, CA (US); Gianluca Iaccarino, Stanford, CA (US); Preyas Shah, Stanford, CA (US)

(21) Appl. No.: 15/435,112

(22) Filed: Feb. 16, 2017

Related U.S. Application Data
(60) Provisional application No. 62/306,906, filed on Mar. 11, 2016.

(51) Int. Cl. G06F 17/50; G06F 17/13

(52) U.S. Cl. CPC G06F 17/5009; G06F 17/13

(57) ABSTRACT

Methods and systems for estimating the flux of spheroidal particles through a pore in a vessel wall using Brownian dynamics (BD) simulation are provided. Also provided are methods of producing a particle based on the BD simulation to provide particles for use in delivering therapeutic agents to a target tissue.

### CROSS-REFERENCE

This application claims the benefit of U.S. Provisional Patent Application No. 62/306,906, filed Mar. 11, 2016, which application is incorporated herein by reference in its entirety.

### STATEMENT REGARDING FEDERALLY SPONSORED RESEARCH

This invention was made with Government support under contract CCNE-T U54 CA 151459-02 awarded by the National Institutes of Health. The Government has certain rights in the invention.

### INTRODUCTION

Nanoparticles (NPs) are being developed for targeted drug delivery or as imaging agents to treat and monitor diseases, such as cancer. Due to advancement in manufacturing techniques on the micro and nanometer scale, NPs are highly customizable as they can be manufactured in different shapes and sizes. NPs are able to evade biological/biophysical barriers due to inertia, and deliver payloads more efficiently compared to free molecules.

One mechanism of transporting NPs to solid tumors is via the process of extravasation, where the NPs may enter small pores (O(100) nm in size) formed in the tumor vasculature and reach the cancerous sites and deliver the drugs.

### SUMMARY

Methods and systems for estimating the flux of spheroidal particles through a pore in a vessel wall using Brownian dynamics (BD) simulation are provided. A method of the present disclosure may include I) obtaining a set of input values for a BD particle flux simulator configured to simulate an environment that includes a vessel containing (i) a medium and (ii) a boundary surface comprising a pore; and a plurality of spheroidal particles in the medium, wherein the input values include values for a plurality of dimensionless parameters comprising: geometric parameters representing (A) an axisymmetric radius, r, of an individual spheroidal particle of the plurality of spheroidal particles, and (B) a principal semi-length, t, of the individual spheroidal particle; and functional parameters representing (A) a shear rate, \dot{γ}, of the medium, and (B) an adsorption rate, k, of the individual spheroidal particle for the pore, wherein the geometric and functional parameters are rendered dimensionless by (1) a time scale of an orientation-averaged diffusivity, D, of the spheroidal particles, and/or (2) a length scale of a radius, a, of the pore; II) simulating a stochastic motion of the plurality of spheroidal particles in the environment based on the input values using the BD particle flux simulator, to generate a simulated value of flux of spheroidal particles through the pore; and III) calculating a dimensionless measure of the flux of spheroidal particles through the pore, based on the simulated value of flux.

Also provided are systems that find use in performing a method of the present disclosure.

### BRIEF DESCRIPTION OF THE DRAWINGS

FIG. 1 is a schematic diagram showing the extravasation process near a tumor.

FIG. 2 is a schematic diagram showing the physical model for mass transport near a pore, according to embodiments of the present disclosure.

FIG. 3 is a schematic diagram showing spherical, and prolate and oblate spheroidal geometries.

FIG. 4 is a schematic diagram showing the capture tube phenomenon, according to embodiments of the present disclosure.

FIG. 5 is a schematic diagram showing a Brownian dynamics (BD) simulation domain and the various coordinate directions and boundary conditions, according to embodiments of the present disclosure.

FIG. 6 is a graph showing BD simulation results, according to embodiments of the present disclosure.

FIG. 7a and FIG. 7b are a collection of graphs showing BD simulation results, according to embodiments of the present disclosure.

FIG. 8a and FIG. 8b are a collection of graphs showing BD simulation results, according to embodiments of the present disclosure.

FIG. 9a and FIG. 9b are a collection of graphs showing BD simulation results, according to embodiments of the present disclosure.

FIG. 10a and FIG. 10b are a collection of graphs showing BD simulation results, according to embodiments of the present disclosure.

FIG. 11a and FIG. 11b are a collection of graphs showing BD simulation results, according to embodiments of the present disclosure.

FIG. 12a and FIG. 12b are a collection of graphs showing BD simulation results, according to embodiments of the present disclosure.

FIG. 13a and FIG. 13b are a collection of graphs showing BD simulation results, according to embodiments of the present disclosure.

FIG. 14a and FIG. 14b are a collection of graphs showing BD simulation results, according to embodiments of the present disclosure.

FIG. 15a and FIG. 15b are a collection of schematic diagrams showing an experimental setup for measuring the rate of diffusion of nanoparticles across a porous membrane, according to embodiments of the present disclosure.

FIG. 16a and FIG. 16b are a collection of images showing an experimental setup for measuring the rate of diffusion of nanoparticles across a porous membrane, according to embodiments of the present disclosure.

FIG. 17a and FIG. 17b are a collection of images and schematic diagrams showing nanoparticles particles modeled by BD simulation, according to embodiments of the present disclosure.

FIGS. 18a-18c are a collection of schematic diagrams of a nanoparticle extravasation BD simulation method, according to embodiments of the present disclosure.

FIG. 19a and FIG. 19b are a collection of schematic diagrams showing a nanoparticle extravasation BD simulation system, according to embodiments of the present disclosure.

FIGS. 20a-20f are a collection of schematic diagrams showing algorithms for a nanoparticle extravasation BD simulator, according to embodiments of the present disclosure.

FIGS. 21a-21d are a collection of schematic diagrams showing nanoparticle extravasation BD simulation methods, according to embodiments of the present disclosure.

FIG. 22 is a schematic diagram showing an algorithm for a nanoparticle extravasation BD simulator, according to embodiments of the present disclosure.

FIGS. 23a-23d are a collection of schematic diagrams showing nanoparticle extravasation BD simulation methods, according to embodiments of the present disclosure.

FIGS. 24a-24c are a collection of images showing a BD simulation snapshot of different particle suspensions in a shear flow, according to embodiments of the present disclosure.

FIG. 25 shows Table 1, showing geometric factors for prolate and oblate spheroids.

FIG. 26 shows Table 2, showing the experimental and BD fluxes for different nanoparticles, according to embodiments of the present disclosure.

FIG. 27 shows a schematic diagram of a computational system for performing a method of estimating the flux of particles through a pore, according to embodiments of the present disclosure.

### DEFINITIONS

A “plurality” contains at least 2 members. In certain cases, a plurality may have at least 10, at least 100, at least 1000, at least 10,000, at least 100,000, at least 10⁶, at least 10⁷, at least 10⁸ or at least 10⁹ or more members.

“Geometric” as used herein, may be used to describe a physical form, e.g., dimensions, size, shape, etc., of an object.

“Functional” as used herein, may be used to describe time-dependent changes, e.g., a change, the rate of a change, etc., or differences in a potential thereof, e.g., differences in the potential for a change, in a system.

A “nanoparticle” may include a particle with the longest dimension in the range of 1 nm to 1,000 nm, e.g., 10 nm to 1,000 nm.

“Time step” as used herein, may refer to a simulation parameter, e.g., for a Brownian dynamics simulation, that describes the lowest resolution of time in a dynamical (i.e., not static) process, such as the motion of particles through space and time. The details of the simulated system in between consecutive time steps may not be resolved or determined. The time step may be a dimensionless parameter.

Before the present disclosure is further described, it is to be understood that the disclosed subject matter is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosed subject matter. The upper and lower limits of these smaller ranges may independently be included in the smaller ranges, and are also encompassed within the disclosed subject matter, subject to any specifically excluded limit in the stated range. Where the stated range includes one or both of the limits, ranges excluding either or both of those included limits are also included in the disclosed subject matter.

Unless defined otherwise, all technical and scientific terms used herein have the same meaning as commonly understood by one of ordinary skill in the art to which the disclosed subject matter belongs. Although any methods and materials similar or equivalent to those described herein can also be used in the practice or testing of the disclosed subject matter, the preferred methods and materials are now described. All publications mentioned herein are incorporated herein by reference to disclose and describe the methods and/or materials in connection with which the publications are cited.

It must be noted that as used herein and in the appended claims, the singular forms “a,” “an,” and “the” include plural referents unless the context clearly dictates otherwise. Thus, for example, reference to “a nanoparticle” includes a plurality of such nanoparticles and reference to “the processor” includes reference to one or more processors and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable sub-combination. All combinations of the embodiments pertaining to the disclosure are specifically embraced by the disclosed subject matter and are disclosed herein just as if each and every combination was individually and explicitly disclosed. In addition, all sub-combinations of the various embodiments and elements thereof are also specifically embraced by the present disclosure and are disclosed herein just as if each and every such sub-combination was individually and explicitly disclosed herein.

The publications discussed herein are provided solely for their disclosure prior to the filing date of the present application. Nothing herein is to be construed as an admission that the disclosed subject matter is not entitled to antedate such publication by virtue of prior invention. Further, the dates of publication provided may be different from the actual publication dates which may need to be independently confirmed.

### DETAILED DESCRIPTION

As summarized above, a method for estimating the flux of spheroidal particles through a pore in a vessel wall using Brownian dynamics (BD) simulation is provided. In general terms, the present disclosure provides analytical and simulation-based methods for modeling the flux of particles, e.g., extravasation of nanoparticles, through pores. By using dimensionless parameters for describing the properties of the system relevant to the model, the present disclosure provides methods that can be generalized to many real-life examples of particle flux through pores.

Further aspects of the present disclosure are now described.

### Methods

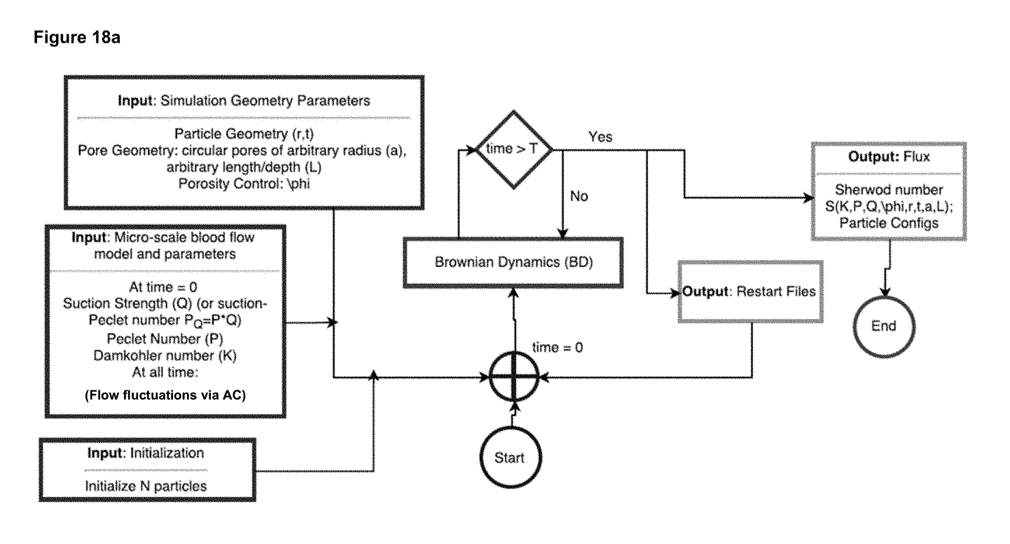

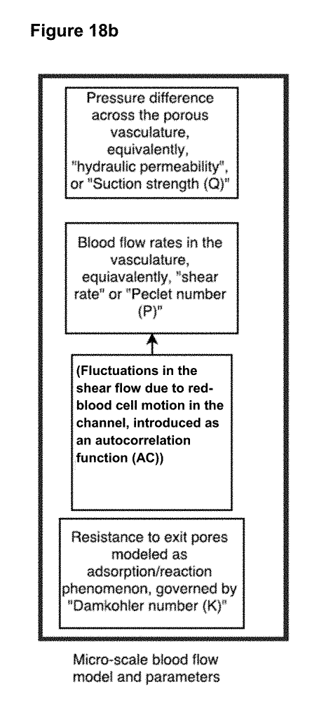

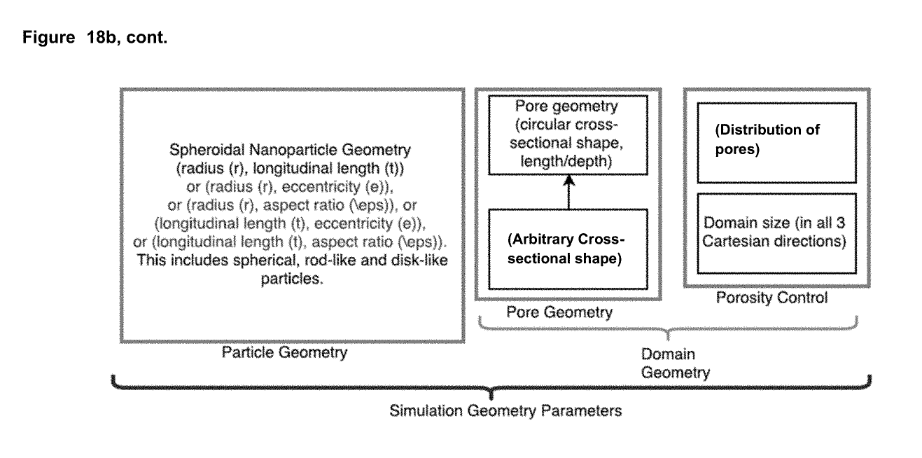

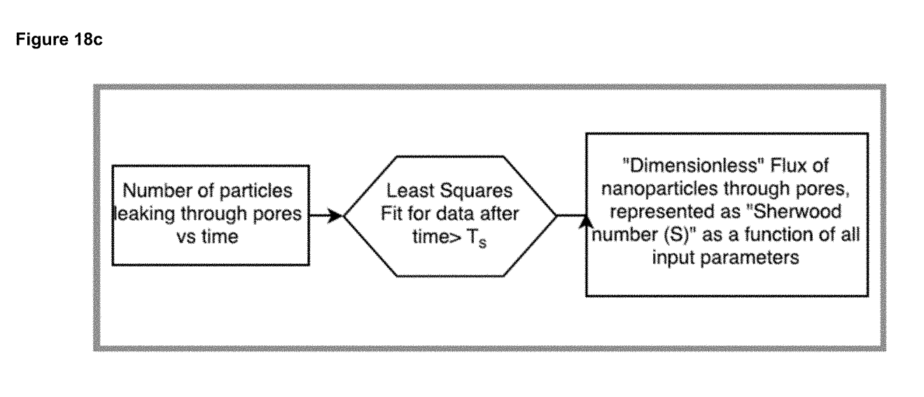

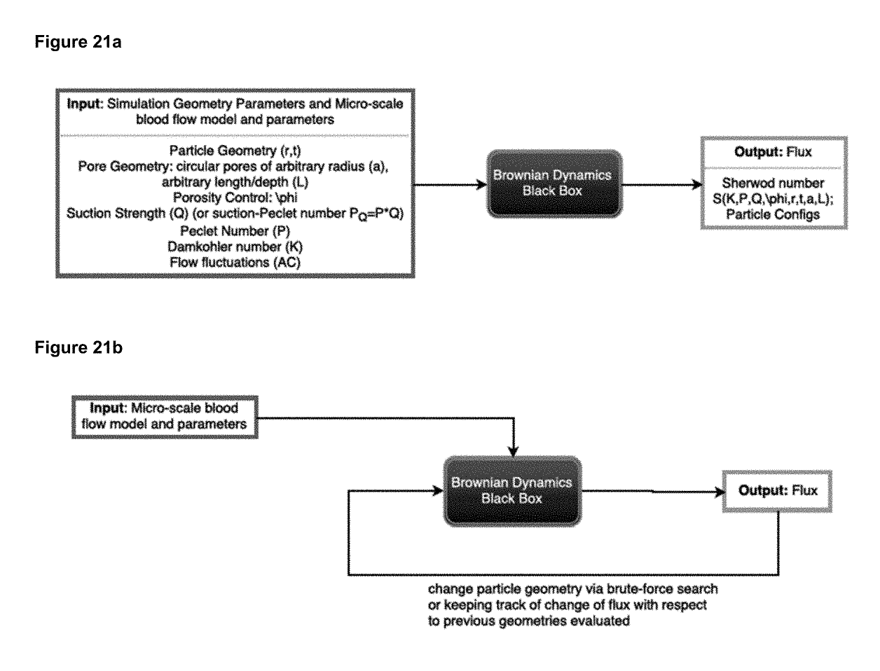

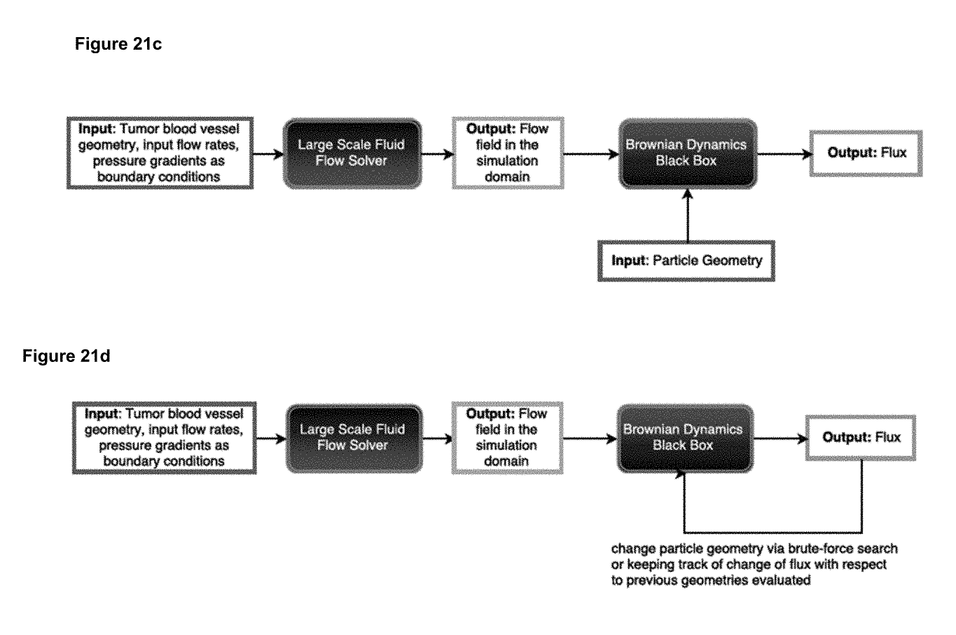

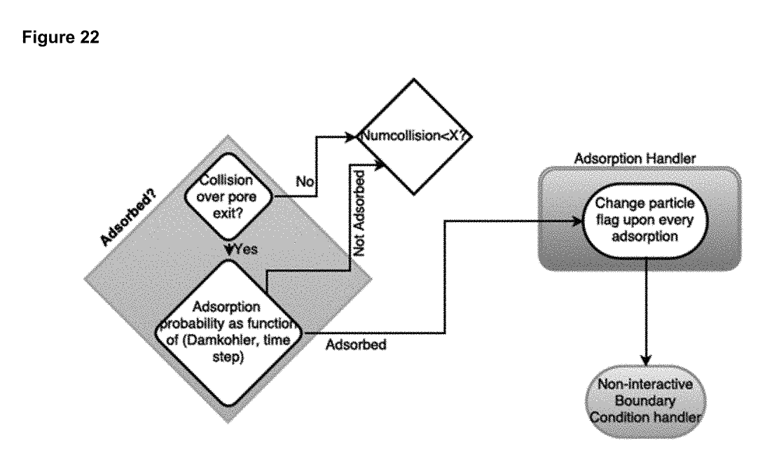

In general terms, a method of the present disclosure may include providing simulation inputs to a Brownian dynamics (BD) simulator for extravasation of particles; running a BD simulation based on the simulation inputs through a defined time interval; determining the number of simulated particles that extravasate during the BD simulation over the defined time interval; and calculating a Sherwood number from the number of extravasated, simulated particles, to generate an output that includes the Sherwood number as a function of one or more of the simulation inputs (see, e.g., FIGS. 18a and 21a).

The BD simulation includes a simulation domain, e.g., a volume containing a medium flowing there through, within which the behavior of a particle is to be simulated. The simulation domain may include boundary conditions defining the surfaces that enclose the volume. The simulation domain built into the BD simulator may vary depending on the extravasation system that is being modeled by the present method.

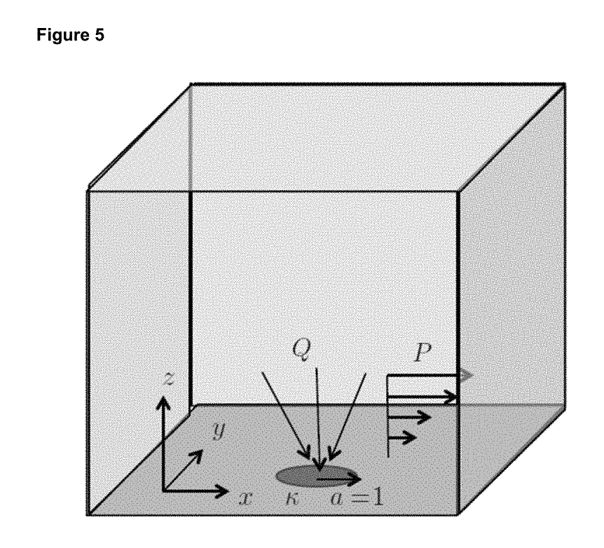

In one embodiment of the present disclosure, a simulation domain includes a rectangular prism, as shown in FIG. 5, defining a top, a bottom and four lateral side surfaces. The four lateral surfaces may have a periodic boundary condition, and the top surface may have a constant flux boundary condition. The bottom surface may include a rigid surface with a pore, e.g., a circular pore, defining a radius, e.g., a unit radius. Thus the boundary condition of the bottom surface may be reflection (i.e., elastic collision) or partial reflection, depending on the location on the bottom surface (e.g., collision with the rigid surface, or partial adsorption at the pore).

The four lateral surfaces may include a first lateral surface opposite a second lateral surface, a third lateral surface opposite a fourth lateral surface, where a line, i.e., straight line, perpendicular to the first and second lateral surfaces may define an x axis, and a line perpendicular to the third and fourth lateral surfaces may define a y axis. A line perpendicular to the top and bottom surfaces may define a z axis oriented in a direction from the bottom surface to the top surface.

With reference to FIG. 18a, a flow chart of an embodiment of the present method is shown. Simulation inputs, such as geometry parameters, flow model parameters, and initialization parameters (e.g., number of particles), are provided to the BD simulator and the simulator is stepped through multiple time steps, until time elapsed, t, is greater than a predefined time interval, T. At that time, the Sherwood number for the stimulation run is calculated and an output that includes the Sherwood number is generated. The simulation may be restarted again with the same set of simulation inputs, and the stimulation repeated a number of times to generate a set of outputs containing Sherwood numbers for the same simulation input. An average of the Sherwood numbers for all stimulation runs with the same simulation inputs may be used as the Sherwood number representing the simulation input parameters.

The geometry parameters and the flow model parameters of the medium for use in an embodiment of the present method are described in FIG. 18b. Geometry parameters may include particle, pore and porosity geometry parameters. The particle geometry may be parametrized based on a spheroidal geometry, including spherical, rod-like and disk-like geometries. Suitable particle geometry parameters include the radius, axisymmetric radius, length, principle semi-length (i.e., semi-length along a principal axis of a particle), aspect ratio and eccentricity. The pore geometry parameters may represent a circular cross-sectional shape, such as the radius, or the length/depth of the pore. The pore geometry may in some cases include arbitrary cross-sectional shapes. The porosity parameter may include the size of the modeled volume. In some cases, the distribution of the pores on the surface may be a simulation input parameter to the BD stimulator. The geometry parameters used in the simulation may be a dimensionless geometry parameter (e.g., a dimensionless radius=(axisymmetric radius)/(pore radius); a dimensionless principal semi-length=(principle semi-length)/(pore radius), etc.).

The flow of the medium, e.g., blood, in the simulation domain may be modeled at the micro-scale with parameters for flow rates, pressure difference across the pore in the bottom surface, and the resistance to exit from the pores. The flow parameters used in the simulation may be a dimensionless flow parameter. The flow rate may be parametrized by the shear rate or the Peclet number (P); the pressure difference across the pore may be parameterized by a hydraulic permeability, suction strength (Q) or suction-Peclet number (P_{Q}); and the resistance to exit may be modeled as an adsorption/reaction phenomenon and parametrized by the Damköhler number (κ). The flow model parameter, e.g., the flow rate, may be a constant value defined at time, t=0, or may be modeled to fluctuate with time using, e.g., an autocorrelation (AC) function.

The result of a BD simulation run using a set of simulation inputs may include the number of particles that have extravasated (i.e., passed through the pore) as a function of time represented by the time steps of the simulation run (FIG. 18c). The extravasation data may be fit with a regression line, e.g., least squares regression, and the slope of the regression may provide a dimensionless flux of the particles through the pore. The flux may be represented as a Sherwood number (S) as a function of the simulation input parameters. The output may also include the particle states simulated at one or more, e.g., all, time steps of the run.

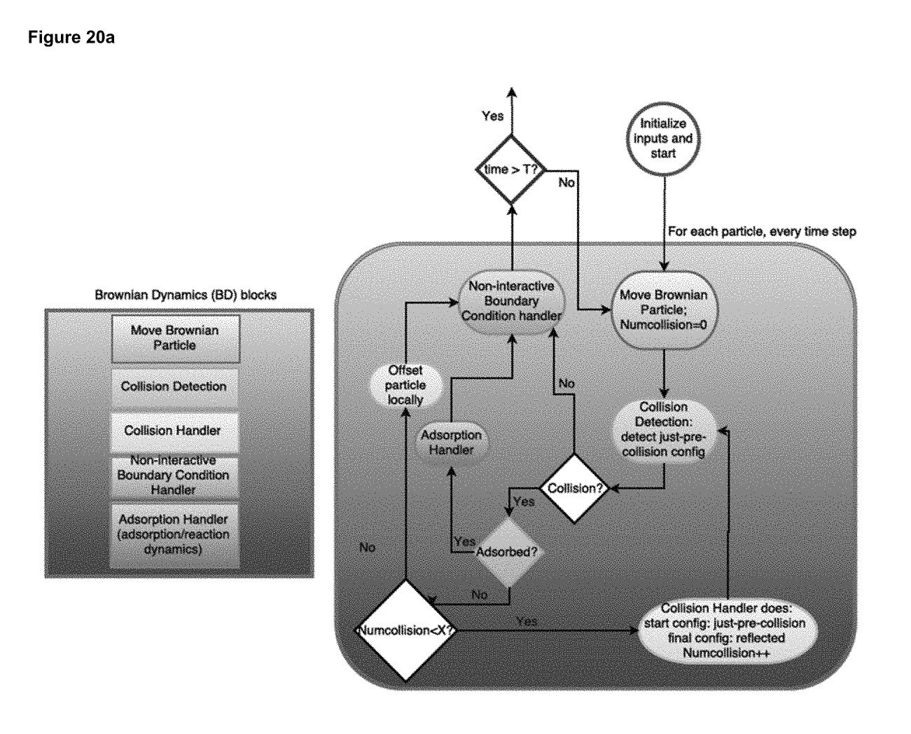

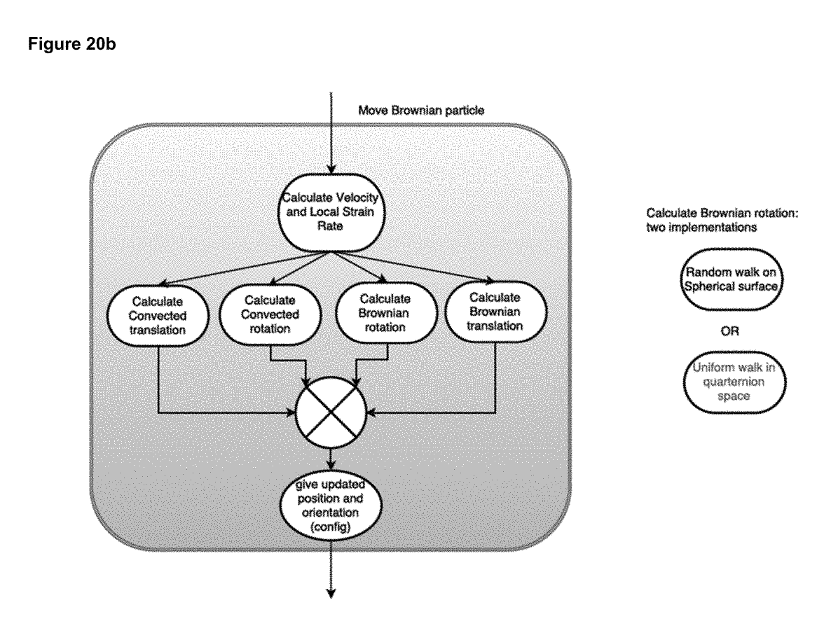

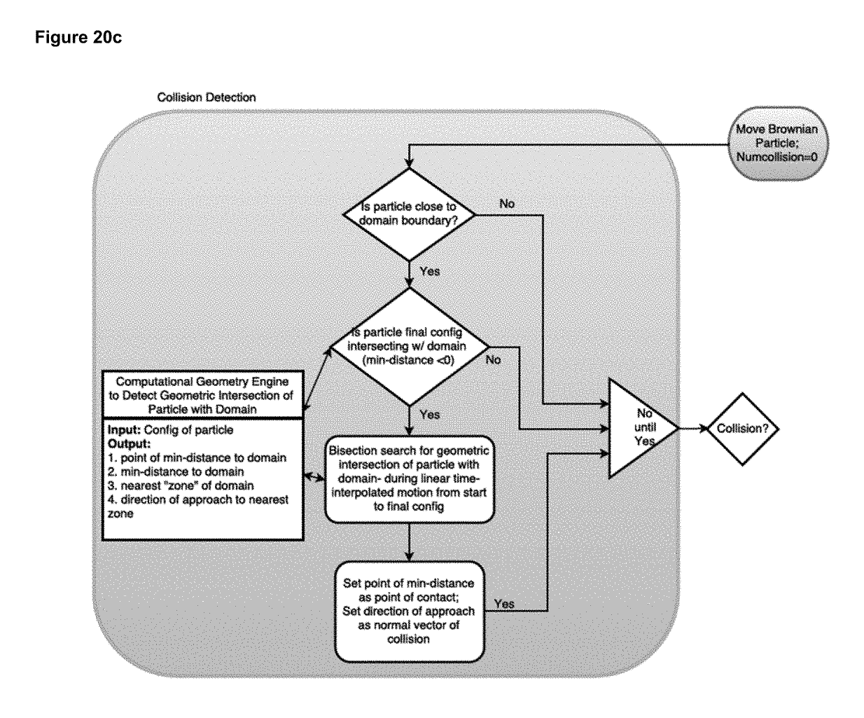

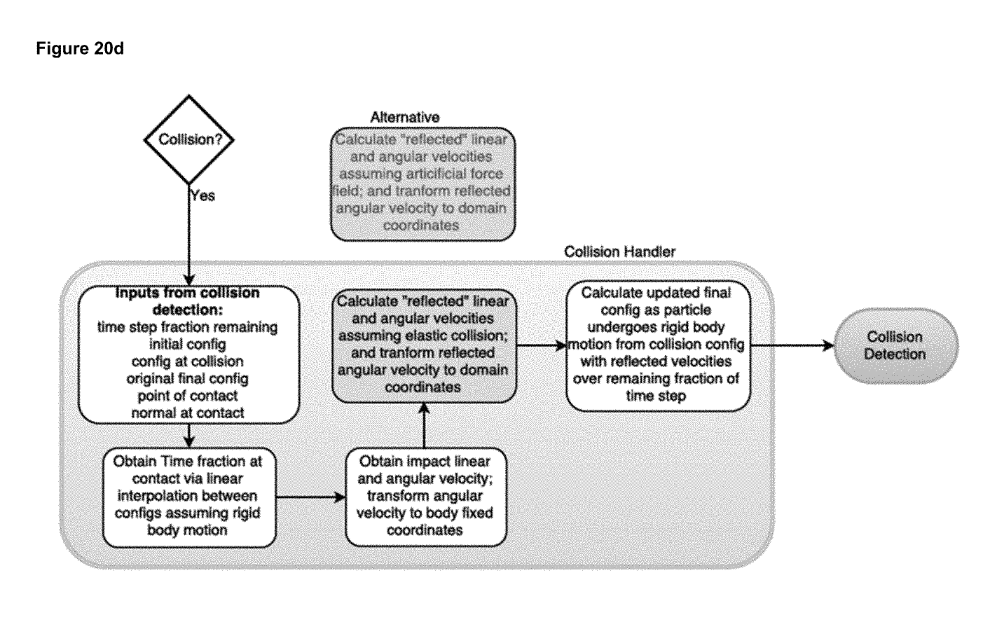

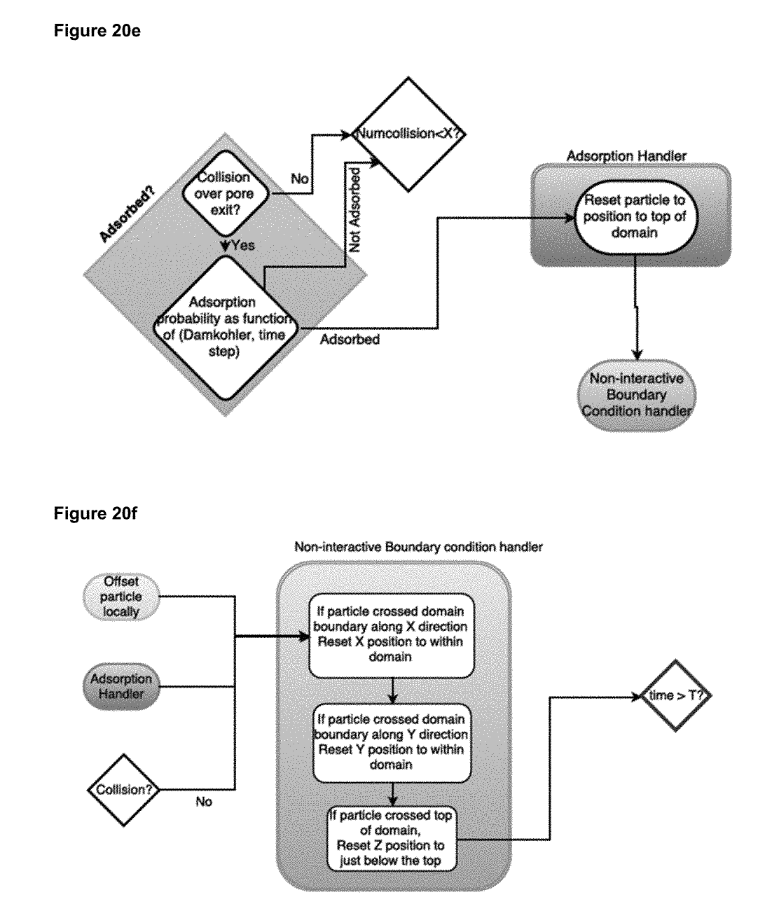

An embodiment of the present BD simulator, and modules thereof, is described in FIGS. 20a-20f. The BD simulator may include an algorithm for modeling motion of a simulated particle and evaluating the consequence of the motion (FIG. 20a). The algorithm may include a collection of modular blocks (“Brownian Dynamics blocks”) that are configured to process different steps of the algorithm. The particle may be simulated as point particle, or may have an arbitrarily shaped finite size. At the start of a simulation run for a single particle, the BD simulator may receive a set of simulation inputs, as described above, for initializing the simulation run.

For each time step, the particle is modeled as a Brownian particle and repositioned from an initial state within the domain to an updated state, e.g., updated position and orientation (“Move Brownian particle”). The updated state is evaluated for any collision with the pore-containing domain boundary of interest, e.g., the bottom surface of the rectangular prism simulation domain, that would be expected based on the updated state, and any appropriate particle geometry parameters (e.g., particle size, shape and orientation) (“Collision Detection”). If a collision is detected based on the updated state, the collision event is evaluated as to whether there is any adsorption at the pore, or is reflected off the surface (“Adsorbed?”). A particle that is adsorbed at the pore is repositioned to the top of the domain (i.e., at the top surface) (“Adsorption Handler”).

If the particle is reflected off the surface, the number of collisions that has occurred during the current time step is evaluated relative to a threshold number. If the number of collisions is less than the threshold number, the collision is modeled as an elastic collision, the state of the particle is updated to a post-collision state, e.g., post-collision position, and the number of collisions is increased by one (“Collision Handler”). The post-collision state is then further evaluated for any collision with the pore-containing domain boundary, e.g., the porous rigid surface (“Collision Detection”). If the number of collisions is above the threshold number, the particle position is locally offset to a position within the domain.

If the updated state, e.g., updated position, does not result in a collision with the pore-containing domain boundary, e.g., the porous rigid surface, or the particle is repositioned to the top surface upon adsorption at the pore, or the position of the particle is locally offset, the position of the simulated particle is evaluated relative to the domain boundaries along each of the lateral or top surfaces and the position of the simulated particle updated if the particle is outside the domain (“Non-interactive Boundary Condition handler”).

Motion of the simulated particle is simulated as a Brownian particle, and is shown in FIG. 20b (“Move Brownian Particle”). The algorithm includes first calculating the velocity field and the local shear rate. The velocity field and local shear rate are used to calculate the translation and rotational motion of the simulated particle due to convection and diffusion (i.e., Brownian motion). These are combined to provide an updated state of the simulated particle. In some embodiments, the Brownian rotation may be calculated based on a random walk on a spherical surface, or based on a uniform walk in quaternion space.

The collision detection algorithm may be described with reference to FIG. 20c (“Collision Detection”). The updated state of the simulated particle is first evaluated based on its distance to the domain boundary, e.g., the porous surface. If the updated state has a position that is close to the pore-containing domain boundary, (e.g., the distance between the updated position and the porous rigid surface is less than a threshold distance), the minimal distance between the particle and the pore-containing domain boundary, (i.e., the distance between an edge of the simulated particle with a finite size that is closest to the porous rigid surface, and the porous rigid surface) is evaluated. If the minimal distance is less than 0, a bisection search is performed along the particle's rigid body motion trajectory, linearly interpolated between the state immediately prior to the updated state, to the updated state, to identify the point at which the particle intersects the pore-containing domain boundary (i.e. set the minimum distance between the particle and the pore-containing domain boundary during the bisection search as point of contact). The direction of approach of the particle is defined to be the normal vector of collision.

Calculating the minimum distance between the particle and the pore-containing domain boundary in the updated state or during the bisection search may be performed with a computational geometry engine that uses the state of the particle (including the position, orientation and shape of the particle) as an input, and generates an output containing 1) the point on the particle (e.g., on the particle's surface in a point-cloud presentation) with the minimum distance among different zones of the pore-containing domain boundary, where the different zones may include the planar wall of the domain boundary, the curved wall circumscribing the pore, the entrance of the pore, and the end of the pore opposite the entrance; 2) the minimum distance; 3) the zone of the pore-containing domain boundary nearest to the particle; and 4) the direction of approach of the particle to the zone (e.g., the vector of the updated or the intermediate position during the bisection search, and the input position, e.g., the position immediately prior to the updated state).

If the particle is not close to the pore-containing domain boundary, or the minimal distance between the particle and the pore-containing domain boundary is 0 or greater, no collision is detected. Otherwise, a collision is detected.

In the event that a collision of a simulated particle with the pore-containing domain boundary is detected, the collision point of contact on the domain boundary is evaluated with respect to the position of the pore (FIG. 20e; “Adsorbed?). If the collision is over the pore, the particle is adsorbed to the pore with a probability determined by a probability function based on the Damköhler number (κ) and the time step size. If the particle is adsorbed, the particle configuration, e.g., particle position, is set to the top of the domain (“Adsorption Handler”).

In some embodiments, the simulation domain geometry is fully symmetric, such that a particle remains in the simulation domain upon adsorption to the pore (e.g., the adsorption is treated as a physical motion of the particle from one side of the domain to the opposite side). In such cases, a simulated particle may be associated with a flag, and adsorption of a simulated particle upon collision over a pore may result in changing the flag to indicate that the particle has been adsorbed by a pore.

If the collision point of contact is not over the pore, or if the particle collision over the pore does not result in an adsorption of the particle, the total number of collisions that was detected in the current time step is evaluated with respect to a threshold number. If the number of collisions is less than the threshold number, the collision is modeled as an elastic collision, and the state of the particle is updated to a post-collision state, e.g., post-collision position (FIG. 20d; “Collision Handler”). To determine the post-collision state, inputs from the collision detection step (e.g., the fraction of the time step remaining based on the position of the particle at which the collision is detected; the state of the particle immediately prior to the post-collision state (e.g., at the start of the time step); interpolated state of the particle at the collision point; the updated state of the particle; the point of contact on the domain boundary; and the normal vector of collision) are provided to first obtain the time fraction at contact via linear interpolation between states assuming a rigid body motion. The collision impact linear and angular velocity is calculated from the inputs, and the angular velocity is transformed into particle body-fixed coordinates. Then, elastic collision is modeled to calculate the reflected linear and angular velocities, and the reflected angular velocity is transformed to the domain coordinates. Alternatively, an artificial force field may be modeled to calculate the reflected linear and angular velocities. The reflected linear and angular velocities are used to determine the post-collision state of the simulated particle as it undergoes rigid body motion from the collision state over the remaining fraction of the time step. The number of collisions in the time step is increased by one, and the post-collision state is then evaluated for collision detection.

When the simulated particle does not interact with the pore-containing domain boundary, or has exceeded the threshold number of collisions in the time step, or is adsorbed at the pore and repositioned to the top surface of the domain, the particle state, e.g., particle position, is evaluated with respect to the lateral and top domain boundaries (FIG. 20f; “Non-interactive Boundary condition handler”). If the particle in the updated state has crossed the domain boundaries along the x direction (e.g., parallel to the direction of flow of the medium), the x position of the particle is set to be within the domain. If the particle in the updated state has crossed the domain boundaries along the y direction (e.g., perpendicular to the direction of flow of the medium), the y position of the particle is set to be within the domain. If the particle in the updated state has crossed the domain boundary opposite the pore-containing domain boundary along the z direction (e.g., the top surface of the simulation domain), the z position of the particle is set to be just within the domain boundary opposite the pore-containing domain boundary.

When the particle state, e.g., particle position, is confirmed and/or set to be within all the domain boundaries, and thus within the simulation domain, the total amount of time spent in the simulation run is evaluated with respect to a threshold time. If the total amount of time is less than the threshold time, the state of the simulated particle is updated according to the Brownian particle motion, as described above, for the next time step. If the total amount of time is equal to or greater than the threshold time, the result of the simulation is generated as an output, as described above, and in some cases, another simulation run is started using the same simulation inputs. Thus in some embodiments, the BD simulation is reiterated for a defined number of times (such as twice or more, e.g., three times or more, 5 times or more, 10 times or more, including 20 times or more), to generate multiple sets of output variables for a set of simulation input parameters. In some cases, the extravasation rate, as represented by the Sherwood number, corresponding to a particular set of simulation input parameters may be defined as the average of all the Sherwood numbers obtained from multiple iterations of the BD simulation using the same simulation input parameters.

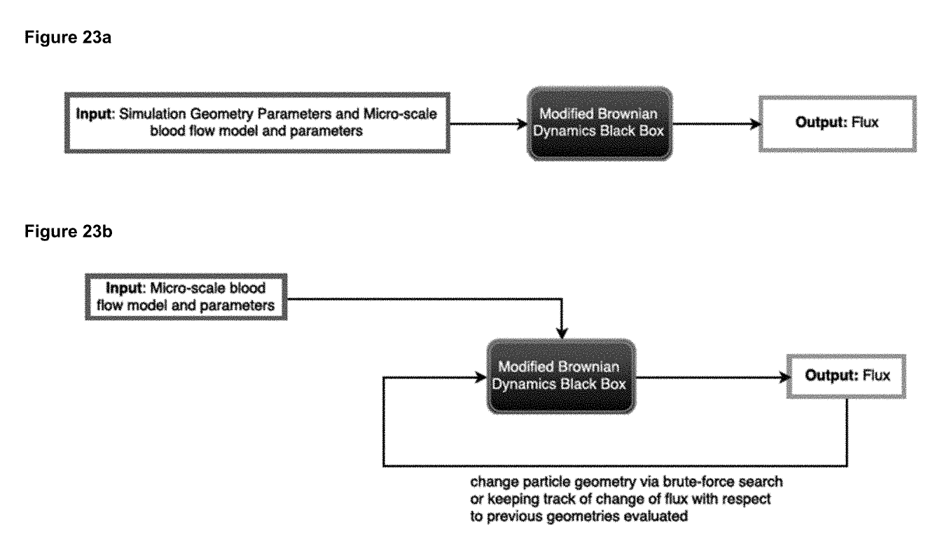

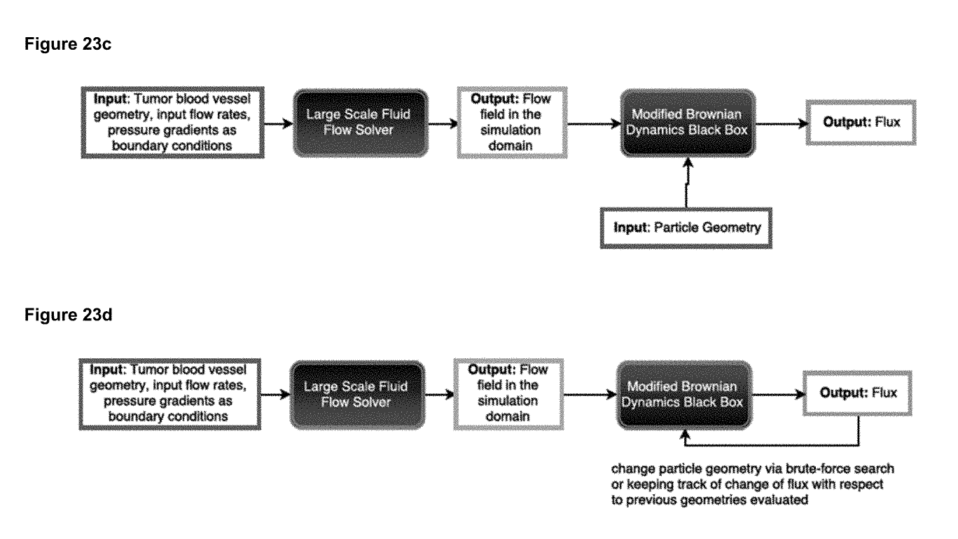

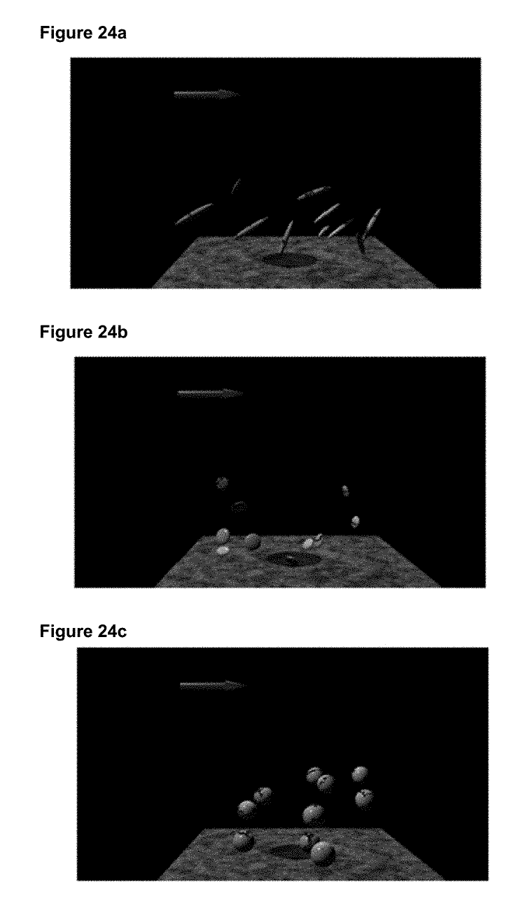

The BD simulation method for modeling nanoparticle extravasation, as described herein, may be used in a variety of applications where the use of nanoparticles for administering active agents to an individual in need is desired. Thus, aspects of the present disclosure include a method for designing a nanoparticle for administration to an individual, where the method includes providing a set of simulation input parameters to a BD nanoparticle extravasation simulator, as described herein, and obtaining an output containing an estimated flux of nanoparticles out of a luminal compartment of a vascular tissue, where the nanoparticles have a shape parametrized by a first subset of the simulation input parameters and luminal compartment of the vascular tissue is parametrized by a second subset of the simulation input parameters (FIGS. 21a and 23a). The first subset of simulation input parameters may include the particle geometry parameters, including radius, axisymmetric radius, length, principle semi-length (i.e., semi-length along a principal axis of a particle), aspect ratio and eccentricity. The second subset of simulation input parameters may include the vascular tissue luminal domain parameters, such as pore geometry (radius, and/or the length/depth of a pore), porosity, shear rate or the Peclet number (P), the pressure difference across the pore (e.g., a hydraulic permeability, suction strength (Q) or suction-Peclet number (P_{Q})), the resistance to exit through the pore (e.g., Damköhler number (κ)), and flow fluctuations.

The present method provides a way to predict the extravasation rate of nanoparticles having a shape modeled by the particle geometry parameters from a porous vascular compartment having geometric and flow properties modeled by the domain geometry and flow parameters (e.g., vascular tissue luminal domain parameters), and may predict the effectiveness of the nanoparticles having a specific shape as a delivery vehicle to deliver active compounds, e.g., drugs, to a target site of interest in an individual, e.g., a patient, through the vascular system.

In some cases, the particle geometry parameters are varied to determine the range of shapes for the nanoparticle to achieve a desired extravasation rate, and therefore a desired rate of delivery of any active agent associated with the nanoparticle. In some embodiments, the particle geometry parameters are chosen arbitrarily for a BD simulation run and the simulation is repeated using different particle geometry parameters until the desired extravasation rate is achieved.

In some embodiments, particle geometry parameters are modified based on the result of an earlier BD simulation run using an initial set of parameters, and the modified particle geometry parameters are then used to run another BD simulation (FIGS. 21b, 21d, 23b and 23d). The modification rules for modifying the particle geometry parameters between each run of the BD simulation may be any suitable modification rule, e.g., a modification rule determined empirically, based on previous simulations, etc. In some cases, the modification rule is individual specific, nanoparticle specific, tissue specific, and/or disease specific (e.g., tumor specific).

The vascular tissue luminal domain parameters may be a general set of parameters that is non-specific with respect to the target (e.g., non-specific to the individual, tissue, disease, etc.), of may be a specific set of parameters selected based on known and/or modeled properties of the target tissue and/or disease. In some embodiments, the fluid flow parameters of the simulation input is derived from a large-scale fluid flow solved that solves for the fluid flow in the vascular system of interest (e.g., a network of blood vessels in a tumor) (FIGS. 21c, 21d, 23c and 23d). Thus, in some embodiments, the method includes providing a tissue and/or disease specific vasculature input (e.g., tumor blood vessel-specific geometry, flow rate, pressure gradients, etc.) to a large scale fluid flow solver (using, e.g., the Lattice Boltzmann method, Stochastic Eulerian Lagrangian Method, finite volume method, etc.) to obtain a fluid velocity field, which may be used as a simulation input parameter for the flow rate in the BD simulation.

The simulation input parameters may be constrained by any other additional considerations, as desired. In some cases, the particle size is larger than a size that allows renal clearance, and is smaller than a size that allows phagocytic clearance (e.g., in the liver or spleen). Thus, in some embodiments, the particle size (e.g., axisymmetric diameter) that is explored using the BD simulation of the present disclosure is about 5 nm or more, e.g., about 10 nm or more, about 15 nm or more, including about 20 nm or more, and in some embodiments is about 200 nm or less, e.g., about 100 nm or less, about 75 nm or less, including about 50 nm or less. In some embodiments, the particle size (i.e., axisymmetric diameter) that is explored using the BD simulation of the present disclosure is in the range of about 5 nm to about 200 nm, e.g., about 10 nm to about 100 nm, including about 20 nm to about 75 nm.

The fluid flow properties and porosity of a tissue vasculature of interest may be determined using any suitable method. Suitable methods include, without limitation, electron microscopy, computed tomography (CT) or micro-CT scan, window chamber models, etc. Suitable methods are described in, e.g., Hashizume et al., The American journal of pathology 156, 1363 (2000); Hobbs et al., Proceedings of the National Academy of Sciences, USA 95, 4607 (1998); Konerding et al., (2001). 3D microvascular architecture of pre-cancerous lesions and invasive carcinomas of the colon. British journal of cancer, 84(10), 1354; Folarin et al., (2010). Three-dimensional analysis of tumour vascular corrosion casts using stereoimaging and micro-computed tomography. Microvascular research, 80(1), 89-98; Less et al., (1991). Microvascular architecture in a mammary carcinoma: branching patterns and vessel dimensions. Cancer research, 51(1), 265-273; Brizel et al. (1993). A comparison of tumor and normal tissue microvascular hematocrits and red cell fluxes in a rat window chamber model. International Journal of Radiation Oncology Biology Physics, 25(2), 269-276, each of which are incorporated herein by reference.

The present method may find use in designing and optimizing any suitable nanoparticle, e.g., nanoparticles for delivering a therapeutically active compound to an individual in need thereof. The nanoparticle for therapeutic use may be any suitable nanoparticle. Nanoparticles suitable for therapeutic use may be non-toxic and physiologically compatible. Nanoparticles of interest may include any suitable natural and/or synthetic materials, such as, but not limited to, chitosan, dextran, gelatin, alginates, liposomes, starch, branched polymers, carbon-based nanoparticles, polylactic acid, poly(cyano)acrylates, polyethyleinemine, block copolymers, polycaprolactone, quantum dots (such as Cd/Zn-selenides), silica nanoparticles, and ferrofluids (such as superparamagnetic iron oxide nanoparticles).

In some cases, nanoparticles may be surface modified. The surface modification may be any suitable surface modification, including, but not limited to, surface modification with polyethylene glycol (PEG), poly(vinylpyrrolidone) (PVP), dextran, chitosan, pullulan, sodium oleate, dodecylamine, etc.

The nanoparticle may be produced using any suitable method. In some cases, a method of making nanoparticles is a method of making nanoparticles with controllable size and shape. Suitable methods are described in, e.g., Perry et al., Acc Chem Res. 2011 Oct. 18; 44(10): 990-998, which is incorporated herein by reference.

The individual may be a mammal, including humans. An individual includes, but is not limited to, human, bovine, horse, feline, canine, rodent, or primate. In some embodiments, the individual is a human individual.

In some cases, the individual is in need of treatment for a disease, e.g., cancer. The disease may be any suitable disease where the porous nature of the vasculature surrounding a diseased target tissue provides a route for a therapeutic agent to be delivered to the target tissue. In some cases the diseased tissue is a tumor tissue. The tumor may be any suitable tumor, including, but not limited to, a tumor from breast cancer, genitourinary cancer, lung cancer, gastrointestinal cancer, epidermoid cancer, melanoma, ovarian cancer, pancreatic cancer, neuroblastoma, colorectal cancer, head and neck cancer.

The therapeutic agent to be delivered to the target tissue by a nanoparticle designed by the present method may be any suitable therapeutic agent for treating an individual for the disease. Where the disease is a cancer, the therapeutic agent may include, without limitation, doxorubicin, daunorubicin, valrubicin, epirubicin, idarubicin, paclitaxel, docetaxel, cisplatin, carboplatin, oxaliplatin, camptothecin, vincristine, vinblastine, 5-fluorouracil (5-FU), mitomycin, cyclophosphamide, methotrexate, mitoxantron, topotecan, capecitabine, doxifluridine, irinotecan, tegafur, chlorambucil, belotecan, anasterozole, tamoxifen, gleevec, floxuridine, leuprolide, flutamide, zoledronate, streptozocin, vinorelbine, hydroxyurea, retinoic acid, meclorethamine, busulfan, prednisone, testosterone, aspirin, salicylates, ibuprofen, naproxen, fenoprofen, indomethacin, phenyltazone, mechlorethamine, dexamethasone, prednisolone, celecoxib, valdecoxib, nimesulide, cortisone, corticosteroid, gemcitabine, cedrol, and any combinations of the above or derivatives thereof.

### Systems

The methods of the present disclosure can be computer-implemented, such that method steps (e.g., screening, determining, analyzing, calculating, and/or the like) are automated in whole or in part. Accordingly, the present disclosure provides methods, computer systems, devices and the like in connection with computer-implemented methods of performing BD simulations to simulate the flux of particles through pores. Thus, the present disclosure also provides a system that includes one or more processors and a non-transient, computer-readable medium containing instructions that, when executed by the one or more processors, causes the one or more processors to estimating the flux of spheroidal particles through pores using BD simulation.

Values obtained by the present method can be stored electronically, e.g., in a database, and can be subjected to an algorithm executed by a programmed computer. A database may store variables, parameter values and/or threshold values, and have a database structure that allows retrieval of the store variables, parameter values and/or threshold values.

The present disclosure thus provides a computer program product including a computer readable storage medium having a computer program stored on it. In certain aspects, the storage medium is non-transitory (e.g., a storage medium that is not a transitory wave or signal). The program can, when read by a computer, execute relevant algorithms based on the input values obtained from a user. The computer program product has stored therein a computer program for performing the simulation(s) and calculation(s).

The present disclosure provides systems for executing the program described above, which system generally includes: a) a central computing environment; b) an input device, operatively connected to the computing environment, to receive data, wherein the data can include, for example, input values and other information, as described above, inputted by a user; c) an output device, connected to the computing environment, to provide information to the user; and d) an algorithm executed by the central computing environment (e.g., a processor), where the algorithm is executed based on the input values received by the input device, and wherein the algorithm performs a BD simulation based on the input values and any other relevant information stored in a memory location, to estimate the flux of particles through pores.

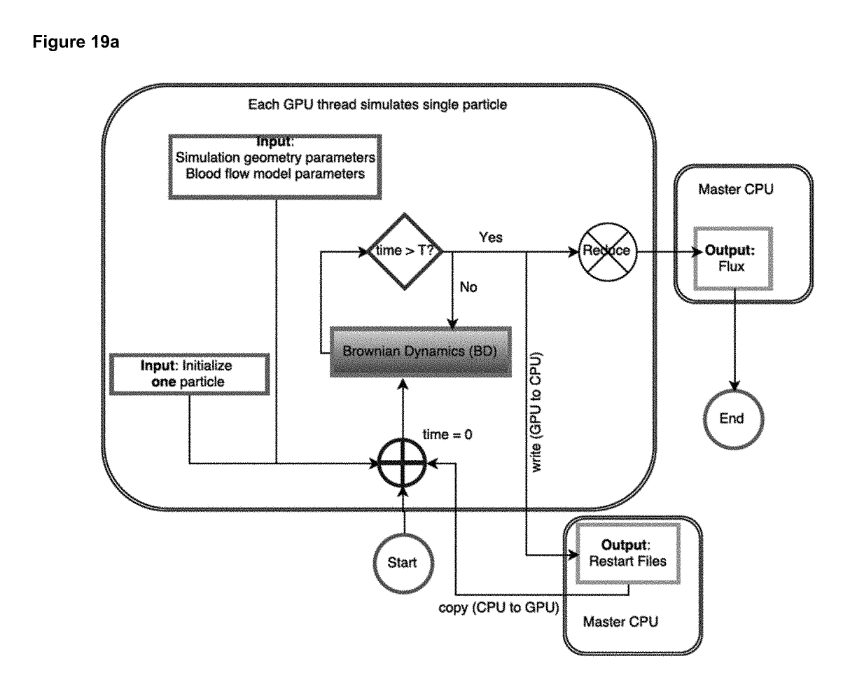

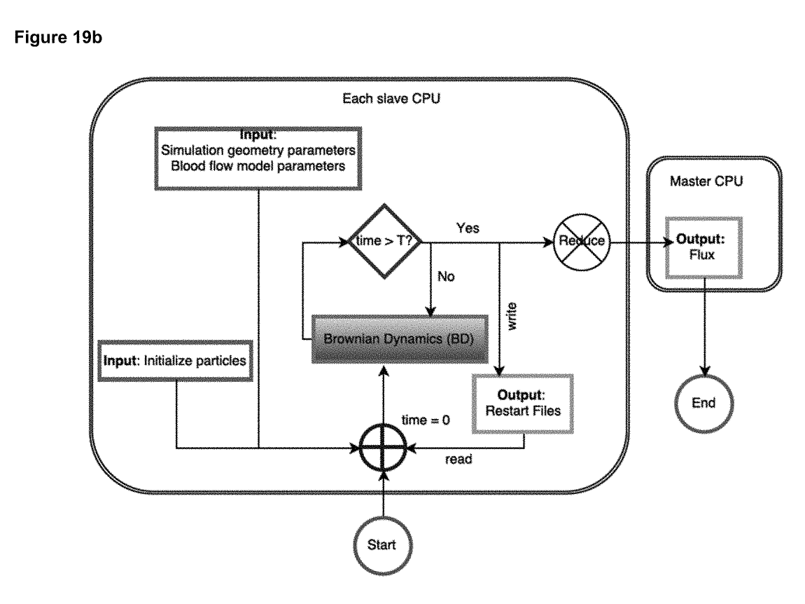

A BD simulator for modeling nanoparticle extravasation, as described herein, may be implemented in a suitable system for running BD simulations. As shown in FIGS. 19a and 19b, in some embodiments, the method is implemented on a computer system, e.g., a distributed computer system, where multiple processors may run the BD simulation in parallel, each processor simulating a single particle at a time for a set of inputs, as described above. The computer system may include graphical processing units (GPUs) that run in parallel (FIG. 19a), or may include central processing units (CPUs) (FIG. 19b), e.g., slave CPUs, that run in parallel. The processors running in parallel, i.e., the slave processors, may have communication lines to a master CPU and may provide the results to the master CPU and be controlled by the master CPU. The master CPU may process the output data of a simulation run by each of the slave processors, and/or may otherwise control the initiation of a BD simulation run.

A system of the present disclosure may also include a non-transient memory that contains the BD simulation program containing instruction that, when executed by a processor, e.g., a slave process, causes the processor to carry out a BD simulation on a single particle using a set of simulation inputs. The non-transient memory may be configured to contain the set of simulation inputs. In some embodiments, the system may be configurable by a user. Any suitable parameter values of the simulation model may be modified by a user, depending on the desired rate of extravasation of a nanoparticle. Thus, in some cases, the system may include input devices configured to receive simulation inputs from a user and to store the user-defined simulation inputs in the non-transient memory for use in a BD simulation.

A system of the present disclosure may include any other suitable components.

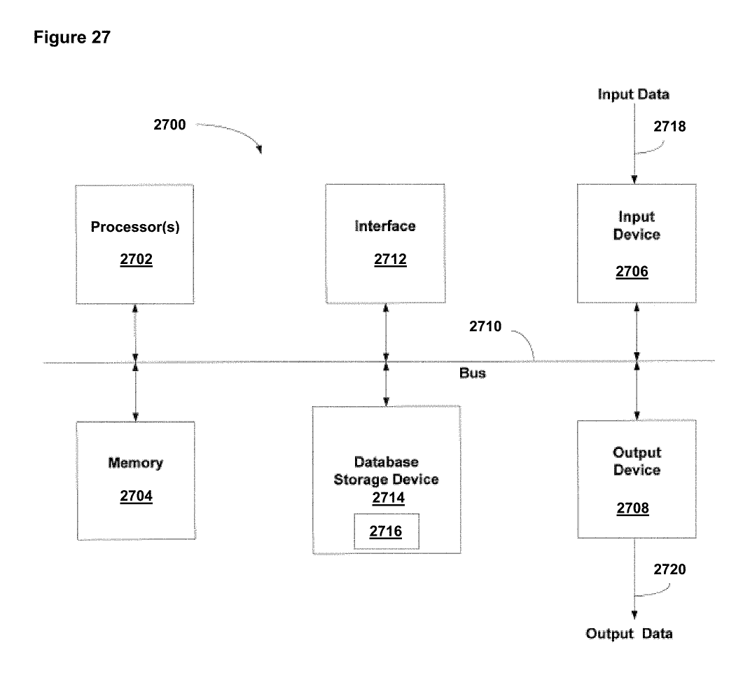

A generalized example of a computerized embodiment in which programs to facilitate execution of the methods of the present disclosure can be implemented is depicted in FIG. 27, which illustrates a processing system 2700 which generally comprises at least one processor 2702, or processing unit or plurality of processors, memory 2704, at least one input device 2706 and at least one output device 2708, coupled together via a bus or group of buses 2710. In certain embodiments, input device 2706 and output device 2708 can be the same device. An interface 2712 can also be provided for coupling the processing system 2700 to one or more peripheral devices, for example interface 2712 can be a PCI card or PC card. At least one storage device 2714 which houses at least one database 2716 can also be provided.

The memory 2704 can be any form of memory device, for example, volatile or non-volatile memory, solid state storage devices, magnetic devices, etc. In certain aspects, the memory includes a non-transitory storage medium (e.g., a storage medium that is not a transitory wave or signal). The processor 2702 can comprise more than one distinct processing device, for example to handle different functions within the processing system 2700. Input device 2706 receives input data 2718 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 2718 can come from different sources, for example keyboard instructions in conjunction with data received via a network.

Output device 2708 produces or generates output data 2720 and can comprise, for example, a display device or monitor in which case output data 2720 is visual, a printer in which case output data 2720 is printed, a port for example a USB port, a peripheral component adaptor, a data transmitter or antenna such as a modem or wireless network adaptor, etc. Output data 2720 can be distinct and derived from different output devices, for example a visual display on a monitor in conjunction with data transmitted to a network. A user can view data output, or an interpretation of the data output, on, for example, a monitor or using a printer. The storage device 2714 can be any form of data or information storage means, for example, volatile or non-volatile memory, solid state storage devices, magnetic devices, etc.

In use, the processing system 2700 may be adapted to allow data or information to be stored in and/or retrieved from, via wired or wireless communication means, at least one database 2716. The interface 2712 may allow wired and/or wireless communication between the processing unit 2702 and peripheral components that may serve a specialized purpose. In general, the processor 2702 can receive instructions as input data 2718 via input device 2706 and can display processed results or other output to a user by utilizing output device 2708. More than one input device 2706 and/or output device 2708 can be provided. The processing system 2700 may be any suitable form of terminal, server, specialized hardware, or the like.

The processing system 2700 may be a part of a networked communications system. Processing system 2700 can connect to a network, for example the Internet or a WAN. Input data 2718 and output data 2720 can be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 2700 illustrated in FIG. 27 may operate in a networked environment using logical connections to one or more remote computers. The remote computer may be a personal computer, a server, a router, a network PC, a peer device, or other common network node, and typically includes many or all of the elements described above.

FIG. 27 is intended to provide a brief, general description of an illustrative and/or suitable example of a computing environment in which embodiments of the methods disclosed herein may be implemented. FIG. 27 is an example of a suitable environment and is not intended to suggest any limitation as to the structure, scope of use, or functionality of an embodiment of the present disclosure.

Certain embodiments may be described with reference to acts and symbolic representations of operations (e.g., such as the flow diagrams shown in FIGS. 18A, 21A-21D, and 23A-23D) that are performed by one or more computing devices, such as the computing system environment 2700 of FIG. 27. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, programmable consumer electronics, network, minicomputers, server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types.

### Computer Program Products

The present disclosure provides computer program products that, when executed on a programmable computer such as that described above with reference to FIG. 27, can carry out the methods of the present disclosure. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g. video camera, microphone, joystick, keyboard, and/or mouse), and at least one output device (e.g. display monitor, printer, etc.).

Computer programs (also known as programs, software, software applications, applications, components, or code) include instructions for a programmable processor, and may be implemented in a high-level procedural and/or object-oriented programming language, and/or in assembly/machine language. As used herein, the term “machine-readable medium” (e.g., “computer-readable medium”) refers to any computer program product, apparatus and/or device (e.g., magnetic discs, optical disks, memory, etc.) used to provide machine instructions and/or data to a programmable processor, including a machine-readable medium that receives machine instructions as a machine-readable signal. According to certain embodiments, the machine-readable medium is non-transitory (e.g., a machine readable medium that is not a transitory wave or signal).

It will be apparent from this description that aspects of the present invention may be embodied, at least in part, in software, hardware, firmware, or any combination thereof. Thus, the techniques described herein are not limited to any specific combination of hardware circuitry and/or software, or to any particular source for the instructions executed by a computer or other data processing system. Rather, these techniques may be carried out in a computer system or other data processing system in response to one or more processors, such as a microprocessor, executing sequences of instructions stored in memory or other computer-readable medium (e.g., a non-transitory computer-readable medium) including any type of ROM, RAM, cache memory, network memory, floppy disks, hard drive disk (HDD), solid-state devices (SSD), optical disk, CD-ROM, and magnetic-optical disk, EPROMs, EEPROMs, flash memory, or any other type of media suitable for storing instructions in electronic format.

### Additional Embodiments

### Dimensionless Parameters of the Microcirculation

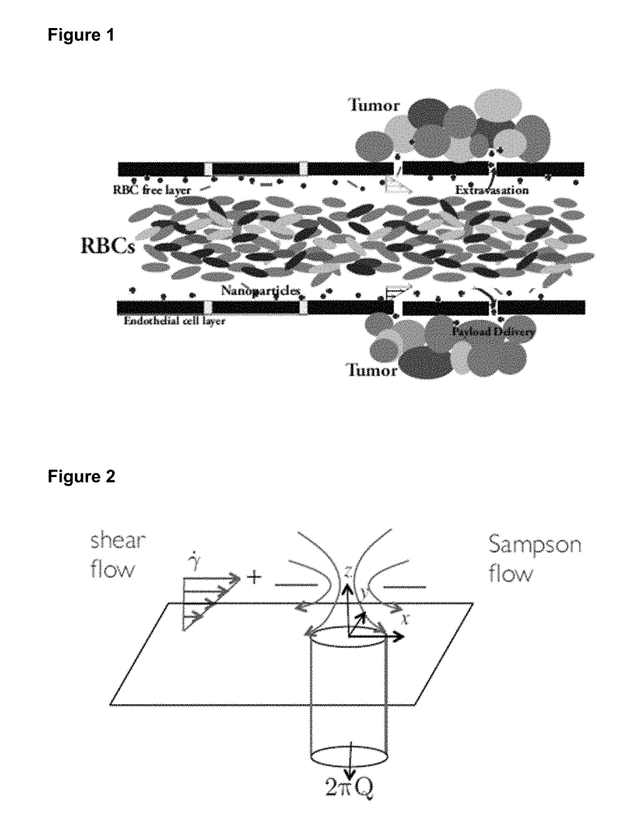

Referring to FIG. 2, the physics of extravasation occurs on the length scale of the pore radius a. The shear rate may be denoted by \dot{γ}. Then a dimensionless suction strength Q can then be defined as

$$Q = \frac{volumetric flux through pore}{2 π \dot{γ} {a}^{3}} . \qquad ( 1 a )$$

The volumetric flow rate is related to the pressure difference across the hole by the relation

$$2 π {a}^{3} \dot{γ} Q = \frac{{ }^{*} ( Δ p ) {a}^{3}}{3 μ} .$$

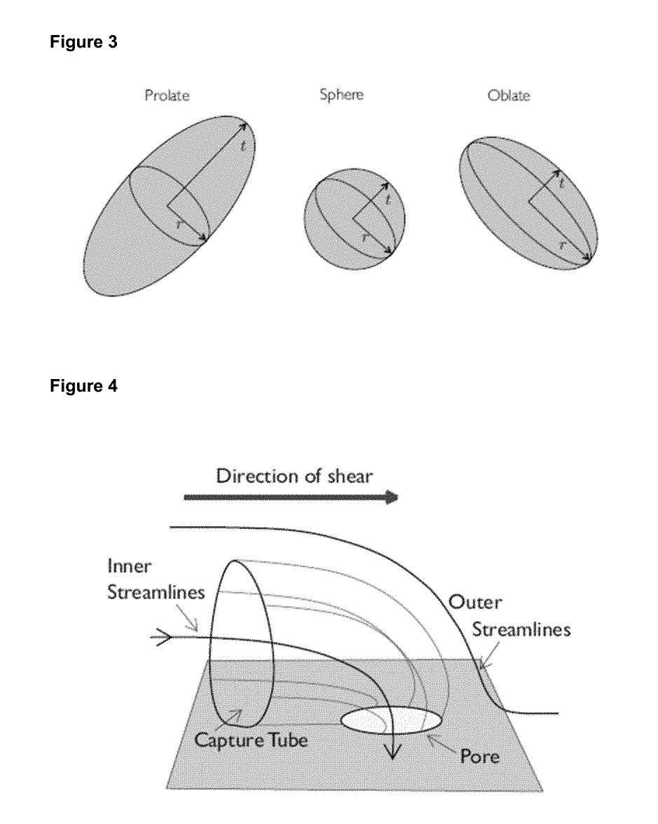

Let r denote axisymmetric radius and t denote the semi-length along the principal axis for a spheroidal particle (or “principal semi-length”). The dimensionless radius and the principal semi-length are defined as (see FIG. 3)

$$α = \frac{r}{a} , β = \frac{t}{a} . \qquad ( 1 b )$$

Point particles sample an isotropic medium while finite sized particles experience a reduced mobility near the pore entrance. This mobility is lumped into a mass transfer resistance coefficient represented by a kinetic reaction (or adsorption) rate k, which allows treatment of the diffusivity in the bulk as a free space diffusivity. Henceforth the phenomenon of extravasation through the pore is treated as equivalent to the adsorption or capture of a particle at the pore. In the case of spheres, D is the isotropic free space diffusivity given by Stokes-Einstein equation. The mobility tensor for spheroidal particles is orientation dependent and, thus, anisotropic. D is then defined as the orientation-averaged diffusion tensor. There are three time-scales pertaining to the problem. The convection time scale is t_{c}=1/\dot{γ} while the diffusion time scale is defined as t_{d}=a²/D. There is also a reaction or adsorption time scale defined as tᵣ=a/k. Henceforth, the two terms will be used interchangeably throughout the text.

Near the pore, reaction and diffusion are competing processes while diffusion and convection compete far away from the pore in the bulk. Suction may be present, in which case convection and diffusion may be competing processes around the pore as well. The ratio of the diffusive time scale to each of these competing physical processes gives rise to the following dimensionless numbers.

$$\begin{matrix}P = \frac{\dot{γ} {a}^{2}}{D} , & ( 1 c ) \\ {P}_{Q} = PQ , & ( 1 d ) \\ κ = \frac{ka}{D} . & ( 1 e )\end{matrix}$$

As mentioned before, P is the shear rate-based Péclet number, which is the ratio of the diffusion to convection time scales. A diffusion dominated process corresponds to a small Péclet number while a convection dominated process corresponds to a large value of Péclet number. Similarly, we define P_{Q} as a suction rate-based Péclet number. Note that from (1a), (1c), and (1d), for a pure suction flow with no shear flow, the suction Péclet number is still finite. The Damköhler number κ is the ratio of the diffusion to reaction time scales. Small values of κ corresponds to a diffusion dominated (or the so called “reaction-limited”) regime while large values correspond to adsorption dominated (or “diffusion-limited”) regime. Thus, for small values of κ, particles face a large resistance to enter the pore (indicative of a large adsorption time scale), and diffuse away before adsorption. At large values of κ, particles are adsorbed before they may diffuse away from the pore and into the bulk.

In tumors vasculature the pore size is approximately 100-200 nm in radius. NPs chosen are smaller than the pore sizes found in the particular tumor, so α<2, β<2. Microcirculatory shear rates are O(1000) s⁻¹, and particle diffusivity is O(10⁻¹¹) m²/s. Thus the Péclet number is O(10), which is evidence that bulk diffusion and convection both influence extravasation. Although our theory assumes P<<1, it holds good even when P=O(10) for most values of κ. The adsorption coefficient at the pore is estimated as κ=O(1). Previous analytical and computational studies of the same problem assumed κ>>1. It is emphasized that the model developed herein lifts this restriction. The strength of suction flow is related to the pressure difference via the fluid viscosity, and for the values of oncotic pressures encountered in tumors, the dimensionless suction strength is at most Q=10.

The Sherwood number, defined rigorously herein, is a dimensionless measure of the extravasation rate (flux) through the pore. As extravasation is a process local to the pore, the nanopore (NP) flux is normalized using the diffusion time scale, pore radius as length scale, and the bulk concentration of particles φ_{∞}, as shown below.

$$S = \frac{flux \cdot B}{D {φ}_{∞}} , \qquad ( 1 f )$$

In this study, the dependence of the Sherwood number on the shear rate and suction rate based Péclet numbers and the Damköhler number is quantified. A singular perturbation theory for point particles is proposed, and BD simulations for general spheroids are developed. The Sherwood number over a range of the Damköhler and the Péclet number that encompasses the physiologically relevant range of values mentioned before are examined.

### Mathematical Theory for Extravasation of Point Particles

### A. Continuum Formulation

Referring to FIG. 2, a cartesian (x, y, z) and a cylindrical (ρ, θ, z) coordinate system with the origin at the center of the circular pore, in the plane of the wall. The two coordinate systems are used interchangeably while writing equations. Also, set the radial coordinate r=(x²+y²+z²)^{1/2}. All bold-faced variables represent vector quantities. In particular, r denotes the position vector of a point in either coordinate systems. In FIG. 2, a dilute bath of Brownian point particles with a far-field concentration of φ_{∞} moves in an external flow above a wall with a pore. The wall normal coordinate is z and the shear flow direction is x. Thus, the normal on the wall and the pore surface pointing into the bulk is n=\hat{z}. An axisymmetric suction flow may also be present in superposition with the shear flow. We pose the problem of extravasation of point particles as an advection diffusion equation of the form (2a), where φ is the concentration scaled by φ_{∞}, and all quantities are scaled with the diffusion time scale, t_{d}=a²/D, and pore radius ‘a’, as length scale. As the equations are linear, we may equivalently set φ_{∞}=1.

∇²φ=PU·∇φ, (2a)

n·∇φ−Pn·Uφ=κφ at z=0,ρ≦1, (2b)

n·∇φ=0 at z=0,ρ>1, (2c)

φ→1 as ρ,z→∞. (2d)

Equation (2b) is a Robin boundary condition describing the balance between the diffusion, reaction and convection at the pore entrance. Equation (2b), together with the no-flux boundary condition (2c) on the wall constitutes a mixed boundary value problem. P and κ are the Péclet and Damköhler numbers, as defined above. A perturbation expansion in P for P<<1 is performed. The dimensionless bulk velocity field is U=(Flux, U_{y}, U_{z})=(U_{ρ}, U_{θ}, U_{z}). This velocity field can be approximated very well by the superposition of shear and Sampson flow fields as shown in (3a). The expression for the dimensionless Sampson velocity field is given by (3b).

$$\begin{matrix}U = z \hat{x} + {U}_{s} , & ( 3 a ) \\ {U}_{s} = {U}_{{s}_{r}} \hat{ρ} + {U}_{{s}_{z}} \hat{z} , \\ where {U}_{{s}_{r}} = \frac{3}{4} Qz \frac{ζ}{ρ} ( {R}_{1} - {R}_{2} ) ( \frac{1}{{R}_{1}} - \frac{1}{{R}_{2}} ) , \\ {U}_{{s}_{z}} = - \frac{3}{4} Q \frac{ζ}{ρ} ( {R}_{1} - {R}_{2} ) ( \frac{ρ - 1}{{R}_{1}} - \frac{ρ + 1}{{R}_{2}} ) , \\ {R}_{1} = {( {z}^{2} + {( ρ - 1 )}^{2} )}^{1 / 2} , \\ {R}_{2} = {( {z}^{2} + {( ρ + 1 )}^{2} )}^{1 / 2} , \\ and ζ = {( 1 - \frac{1}{4} {( {R}_{2} - {R}_{1} )}^{2} )}^{1 / 2} & ( 3 b )\end{matrix}$$

Note that U_{S}=0 at the wall (z=0, ρ>1). Over the pore (z=0, ρ≦1), U_{S}=(0, 0, −3Q(1−ρ²)^{1/2}). When Q=0, U=z\hat{x}. The superposition of the shear and Sampson flows causes the streamlines to form a ‘capture tube’ upstream. Basically the capture tube is a surface that separates the streamlines that enter the pore from those that do not, as illustrated in FIG. 4. The concept of capture tube will be important in explaining some of the numerical results for finite sized particles, described below.

The Sherwood number is the flux through the pore, normalized with the characteristic length scale and diffusivity. Without the loss of generality, set a=1. The Sherwood number is then a function of P, κ, P_{Q} and expressed as an area averaged flux in the integral form (4).

$$S ( κ , P , Q ) = \frac{1}{π} {\int }_{pore} ( \frac{\partial φ}{\partial z} - {PU}_{z} φ ) dA . \qquad ( 4 )$$

There is a contribution to the flux from both diffusion and convection processes.

### B. Singular Perturbation Theory (SPT) Approach

Note that when P<<1 in (2a), the diffusion term has the dominant influence on the physics at the short length scales. Specifically, at wall-normal distances on the order of the pore radius (the inner region), the particles simply diffuse to the pore where their adsorption is controlled by κ. At distances far from the pore (the outer region, where z, ρ˜O(P^{-1/2}), convection effects balance diffusion. Thus a perturbation expansion may be obtained in P (and valid for P<<1) using the method of matched asymptotic expansion. The concentration fields for the inner and outer regions is solved, and their asymptotes at the boundary between the regions are matched. Denote the fields and independent variables in the inner expansion with lowercase letters and those in the outer expansion with uppercase letters.

The inner region corresponds to z, ρ˜O(P^{1/2}) where the following advection-diffusion equations for the inner concentration field, c, are valid.

$$\begin{matrix}{∇}^{2} c = PU \cdot ∇ c , & ( 5 a ) \\ \frac{\partial c}{\partial z} - {PU}_{z} c = κ c at z = 0 , ρ \leq 1 , & ( 5 b ) \\ \frac{\partial c}{\partial z} = 0 at z = 0 , ρ > 1. & ( 5 c )\end{matrix}$$

The convective and diffusive fluxes balance each other at z, p=O(P^{-1/2}). This balance becomes evident by writing the equations (6a)-(6c) for concentration in the outer region, C, using the stretched variables Z=P^{1/2}z, R=^{1/2}r, [symbol] =P^{1/2}ρ, X=P^{1/2}x and so on. Consequently, the balance of fluxes occurs beyond the region Z, [symbol] ˜O(1) that corresponds to the matching of inner and outer solutions.

∇²C=U·∇C, (6a)

n·∇C=0 at Z=0,R>P^{1/2}, (6b)

C→1 as R→∞. (6c)

The standard expansion for the inner concentration field is a power series in the stretch factor P^{1/2}, with field variables as terms of different orders. It will be evident from (17b) that an additional term of poly-logarithmic order is needed, and the expansion appears as

c(r)=c₀(r)+c₁(r)P^{1/2}+c₂(r)P ln P+c₃(r)P+c₄(r)P^{3/2}+o(P^{3/2}). (7)

d

Due to (6c), the outer expansion takes the form

C(r)=1+f(P)C₀(r)+o(f(P)). (8)

Again, f(P) is a scaling factor to be determined through the method of matched asymptotic expansions. After determining the terms of the inner and outer series, we calculate the Sherwood number using the inner series (7) in the integral expression (4). Consequently, the Sherwood number is also expressed as an expansion in P.

$${S}_{spt} ( κ , P , Q ) = \frac{1}{π} {\int }_{pore} ( \frac{\partial c}{\partial z} - {PU}_{z} c ) dA . \qquad ( 9 )$$

As only the expression for Sherwood number is of interest, the various terms in the expansion are not explicitly solved. The integral in (9) is computed, provided the solution to the various terms of the expansion exists. For the sake of clarity, the mathematical details of proving existence of solutions and calculations of integrals are included in the appendix. This approach is detailed in the following sections.

### C. Previous Result: Expansion of the Sherwood Number to O(P^{1/2})

To provide a flavor of the extended perturbation analysis, we briefly summarize the perturbation analysis of Shah et al. (J Eng Math. 2014 Feb. 1; 84(1): 155-171) where the Sherwood number was calculated to O(P^{1/2}), and depends only on P and κ.

1. Inner Expansion: Leading Term

Solving (5a)-(5c) for a solution of the form (7), it is observed that the leading term c₀ satisfies the Laplace's equation and mixed boundary conditions (10a)-(10c).

$$\begin{matrix}{∇}^{2} {c}_{0} = 0 , & ( 10 a ) \\ \frac{\partial {c}_{0}}{\partial z} = κ {c}_{0} at z = 0 , ρ \leq 1 , & ( 10 b ) \\ \frac{\partial {c}_{0}}{\partial z} = 0 at z = 0 , ρ > 1 , & ( 10 c )\end{matrix}$$

Noting that c₀ is axisymmetric, it is expressed as a cylindrical harmonic in the bessel function J₀, which is guaranteed to satisfy the Laplace's equation (10a).

$${c}_{0} = 1 + {\int }_{0}^{∞} {𝒜}_{0} ( s ) {e}^{- sz} {J}_{0} ( s ρ ) ds . \qquad ( 11 )$$

The constant term in the R.H.S above is necessary to match its counterpart in the outer solution (8). We then derive a pair of integral equations for the harmonic form, corresponding to the boundary conditions (10b) and (10c). We solve these integral equations using the classical theory of dual integral equations for mixed boundary value problems. We refer the reader to appendix A1 for details, and quote the solution for c₀ here.

$${c}_{0} = 1 - \frac{π}{2} {\sum }_{n = 0}^{∞} {( - 1 )}^{n} ( 2 n + 1 ) {a}_{n} {\int }_{0}^{∞} \frac{1}{s} {e}^{- sz} {J}_{2 n + 1} ( s ) {J}_{0} ( s ρ ) ds , \qquad ( 12 )$$

where aₙ are coefficients of a spectral expansion and are determined numerically. In the far-field limit (r>>1), as shown in Shah et al. (supra), the asymptotic approximation to the leading term of the inner expansion is given by

$${c}_{0} ∼ 1 - \frac{π {a}_{0} ( κ )}{4 r} , \qquad ( 13 )$$

We note that the leading non-constant term in the inner solution decays as 1/r, which is the classical scaling for a point source solution to the Laplace's equation.

2. Outer Expansion: Leading Term

Recall that C˜1+f(P)C₀. It satisfies the following equations describing advection and diffusion in a shear flow over a wall and a sink at the origin (represented by the delta function).

$$\begin{matrix}{∇}^{2} C = Z \frac{\partial C}{\partial X} , & ( 14 a ) \\ n \cdot ∇ C = δ ( 0 ) at Z = 0 , R > {P}^{1 / 2} , & ( 14 b )\end{matrix}$$

For the theory to work, a solution for C₀ that decays as 1/r in the near-field limit is required so that it matches with the far-field limit (13) of the inner solution. Also note that the Sampson flow field decays like 1/r² at large r, and, thus, has a higher order effect on C₀. Neglecting the Sampson flow results in (14a), which is then justified at vanishingly small Q. It is seen that the expression for Sherwood number resulting from the matching procedure is fairly accurate even at large Q. Problem (14) is solved by taking the Fourier transform of C₀ in the shear (X) and vorticity (Y) directions, and solving the corresponding differential equation (15a)-(15d) in the frequency domain.

$$\begin{matrix}{C}_{0} = {\int }_{- ∞}^{∞} {\int }_{- ∞}^{∞} {\tilde{C}}_{0} exp ( - iKX - iLY ) dKdL , & ( 15 a ) \\ where {\tilde{C}}_{0} = \frac{1}{{π}^{2}} {e}^{i π / 6} {K}^{- 1 / 3} ( \frac{Ai ( s )}{{Ai}^{′} ( {s}_{0} )} ) , & ( 15 b ) \\ s = {e}^{- i π / 6} {K}^{1 / 3} ( Z + i \frac{{K}^{2} + {L}^{2}}{K} ) & ( 15 c ) \\ and {s}_{0} = s {\vert}_{z = 0} . & ( 15 d )\end{matrix}$$

This is the same as the Green's function used by Stone (Physics of Fluids A: Fluid Dynamics 1, 1112 (1989)) to analyze the heat and mass transfer from surface films in shear flow. The near-field behavior of the outer solution (15a)-(15d) was determined by Phillips (The Quarterly Journal of Mechanics and Applied Mathematics 43, 135 (1990)). The asymptotic expansion is shown below in terms of inner variables as R→0.

$$C ∼ 1 - \frac{f ( P )}{{P}^{1 / 2}} \frac{2}{π} ( \frac{1}{r} - {A}_{1} {P}^{1 / 2} - \frac{{A}_{2}}{2} xP ln P - \{ {A}_{2} x ln ( z + r ) - {A}_{3} \frac{xz}{r} \} P - \{ {A}_{4} \frac{x ( {x}^{2} + {y}^{2} - 2 {z}^{2} )}{r ( z + r )} - {A}_{5} x \} P + {A}_{6} ( 5 {x}^{2} + 2 {y}^{2} - 7 {z}^{2} ) {P}^{3 / 2} + o ( {P}^{2} {r}^{2} ) ) , \qquad ( 16 )$$

where A₁=0.318 . . . , A₂=0.125, A₃=0.0625, A₄=0.0625, A₅=0.183 . . . , A₆=0.00948 . . . .

Since the concentration is a continuous field, the leading order terms in both the inner and outer solution asymptotes (13) and (16), respectively, that are valid in the region 1<r<P^{-1/2} are matched to determine f(P). In particular, the following match was required to hold true.

$$\begin{matrix} 1 - \frac{π {a}_{0} ( κ )}{4 r} = 1 - \frac{f ( P )}{{P}^{1 / 2}} \frac{2}{π} \frac{1}{r} . \\ Thus , f ( P ) = \frac{{π}^{2} {a}_{0} ( κ )}{8} {P}^{1 / 2} , and & ( 17 a ) \\ C ∼ 1 - \frac{π {a}_{0} ( κ )}{4} ( \frac{1}{r} - {A}_{1} {P}^{1 / 2} - \frac{{A}_{2}}{2} xP ln P - \{ {A}_{2} x ln ( z + r ) - {A}_{3} \frac{xz}{r} \} P - \{ {A}_{4} \frac{x ( {x}^{2} + {y}^{2} - 2 {z}^{2} )}{r ( z + r )} - {A}_{5} x \} P + {A}_{6} ( 5 {x}^{2} + 2 {y}^{2} - 7 {z}^{2} ) {P}^{3 / 2} + o ( {P}^{2} {r}^{2} ) ) . & ( 17 b )\end{matrix}$$

The remainder of the terms in (17b) is matched with the higher order terms in the inner solution. The inner solution terms is used to compute the Sherwood number to high orders in P^{1/2}.

Note that the O(P^{1/2}) term, c₁, in the inner expansion (7) satisfies the same set of homogeneous equations (10a)-(10c) as c₀. That is, c₁ satisfies the Laplace's equation and the same mixed boundary conditions. Thus, c₁=B₁c₀ with B₁ a non-zero constant to be determined via matching with the O(P^{1/2}) term in (17b). As c₁ has the far-field asymptote of the form c₁˜B₁(1−πa₀(κ)/4r), the constant term in the asymptote must match the term A₁πa₀(κ)=4 in (17b). Thus, B₁=A₁πa₀(κ)/4=0.249 . . . a₀ (κ) and

3. Computing the Sherwood Number to O(P^{1/2})

Notice from (7) and (9) that there is no convective flux contribution to the Sherwood number up to O(P^{1/2}). There is only the diffusive flux contribution coming from c₀ and c₁ at these lower orders. As c₀ is a harmonic function with far-field behavior of πa₀(κ)/4r, the diffusive flux due to it is πa₀(κ)/2, as calculated using Stokes' divergence theorem. The diffusive flux due to c₁ is the same as c₀ multiplied by the factor B₁. The Sherwood number to O(P^{1/2}) is then given by

$${S}_{spt} \approx \frac{π {a}_{0} ( κ )}{2} + \frac{π {{a}_{0} ( κ )}^{2}}{8} {P}^{1 / 2} . \qquad ( 19 )$$

In particular, when P=0, κ→1, a₀(κ) approaches a limiting value such that Sₛₚₜ→4/π.

### D. Expansion of the Sherwood Number to O(P^{3/2})

To expand the inner solution to a higher order than O(P^{1/2}), the theory of dual integral equations and boundary integral methods is used to construct solutions to higher order coefficients (Appxs. C1, D1, and E1). After matching with the remaining unmatched terms in the outer expansion (17b), the contribution to the Sherwood number from each higher order term is computed.

1. Inner Expansion: O(P ln P) Term

It is evident from the governing equations (5a)-(5c) that c₂ in the expansion (7) satisfies the same set of equations as c₀ and c₁. However, we require the far-field asymptote of c₂ to match with the corresponding O(P ln P) term in the near-field asymptote (17b) of the outer solution. Following is the governing equation for c₂.

$$\begin{matrix}{∇}^{2} {c}_{2} = 0 , & ( 20 a ) \\ \frac{\partial {c}_{2}}{\partial z} = κ {c}_{2} at z = 0 , ρ \leq 1 , & ( 20 b ) \\ \frac{\partial {c}_{2}}{\partial z} = 0 at z = 0 , ρ > 1 , & ( 20 c ) \\ {c}_{2} ∼ {B}_{2} x as r \to ∞ , where {B}_{2} = \frac{π {a}_{0} ( κ )}{4} \frac{{A}_{2}}{2} . & ( 20 d )\end{matrix}$$

As detailed in appendix C1, a solution of the form (21) is assumed, which satisfies the Laplace's equation (20a), and has the far-field asymptote (20d).

$${c}_{2} = {\int }_{0}^{∞} {𝒜}_{2} ( s ) {e}^{- az} {J}_{1} ( s ρ ) cos ( θ ) ds + {B}_{2} x . \qquad ( 21 )$$

Using this form, a pair of integral equations involving [symbol] ₂ (s) derived from the no-flux boundary condition (20c) at the wall and adsorption condition (20b) on the pore is obtained (see appendix C1). The dual integral equations for [symbol] ₂ (S) is solved (J. Cooke, The Quarterly Journal of Mechanics and Applied Mathematics 9, 103 (1956); C. Tranter, The Quarterly Journal of Mechanics and Applied Mathematics 3, 411 (1950)). Stoke's divergence theorem is used to compute the integral in (9). It is observed that there is no diffusive or convective contribution to the flux to the circular pore from c₂, as the solution form (21) is antisymmetric in x and symmetric in y.

2. Inner Expansion: O(P) Term

Again, from the governing equations (5a)-(5c), it is seen that c₃ in the expansion (7) satisfies the set of equations (22a)-(22d) shown below. Notice that the Sampson flow velocity Us appears for the first time, in both the bulk equation as well as the boundary condition at the pore. We require that the far-field asymptote of c₃ matches with the corresponding O(P) term in the near-field asymptote (17b) of the outer solution.

We use the technique of superposition detailed in appendix D1 to solve for c₃. To give a brief description, we express c₃ as a sum of two terms: c₃=c₁₃+c₂₃ such that c₁₃ satisfies the asymptotic conditions (22d) for the advection-diffusion equations without the Sampson flow terms. On the other hand, c₂₃ satisfies the complementary equations that include the Sampson flow terms, but decays as O(1/r²) in the far-field limit. Thus, c₁₃ dominates c₂₃ in the far-field asymptotic limit. In appendix D1, both c₁₃ and c₂₃ are shown to exist as solutions to boundary integral equations. We will see in section IIID4 that there is no contribution to flux from c₁₃ as the asymptotic form (22d) imposes an antisymmetric constraint on c₁₃. However, the term c₂₃ has both a diffusive and convective contribution to flux.

3. Inner Expansion: O(P^{3/2}) Term

The term c₄ in (7) satisfies the set of equations (23a)-(23d) below. The far-field asymptote of c₄ is required to match the O(P^{3/2}) term in the near-field asymptote of the outer expansion (17b).

Note that the governing equations for c₄ are the same as that for c₃ except for the asymptotic behaviors enforced by differing matching conditions. Moreover, in contrast with c₃, the solution to c₄ is not axisymmetric, and the corresponding integrals in the flux expression are not identically zero. Again, we split c₄ into parts that are solved for separately. In this case, we write c₄ as a sum of 5 parts: c₄=c₄^{∞}+\tilde{c}₄, \tilde{c}₄=\tilde{c}₁₄+\tilde{c}₂₄+\tilde{c}₃₄+\tilde{c}₄₄, each one being a solution to an advection-diffusion equation (see appendix E1). As in the case of c₂ and c₃, these solution methods are based on the theory of dual integral equations and boundary integral equations. The contribution to Sherwood number of these various superposition components is investigated. These components are found to contribute either no flux or an easily calculated flux, as seen in appendix E2.

The terms c₂, c₃, and c₄ also contribute some faster decaying terms in their far-field asymptotic expansions. These terms will determine the strength of the second order term in the outer expansion via matching with its near-field asymptote. However, the analysis is limited to the expansion obtained from matching the first order outer term.

4. Computing the Sherwood Number to O(P^{3/2})

As the Sherwood number has both diffusive and convective components, the diffusive and convective contributions of all the terms in (7) is calculated separately, to O(P^{3/2}).

Convective Flux.

The dimensionless convective flux, S_{C}=(1/π) ∫ₚₒᵣₑPU_{z} cdA, is the area average of the mass flow rate due to flow velocity over the pore. Thus, there is no convective flux contribution up to O(P^{1/2}). As shown in appendix A2, the convective flux of O(P) is given by

$$\frac{- 1}{π} {\int }_{pore} {PU}_{z} {c}_{0} dA = Q ( 2 - ( 1.388 {a}_{0} ( κ ) - 0.462 {a}_{1} ( κ ) ) P .$$

Similarly, as shown in appendix B1, we obtain the O(P^{3/2}) flux term given by

$$\frac{- 1}{π} {\int }_{pore} {P}^{3 / 2} {U}_{z} {c}_{1} dA = \frac{{Qa}_{0} ( κ )}{2} ( 1.388 {a}_{0} ( κ ) - 0.462 {a}_{1} ( κ ) ) {P}^{3 / 2} .$$

The convective contributions from higher order terms of the inner expansion are neglected, as they are all O(P^{3/2}). The total convective component of the Sherwood number is then given by

S_{C}=2Q(1−(1.388a₀(κ)−0.462a₁(κ)))P+½a₀(κ)Q(1−(1.388a₀(κ)−0.462a₁(κ)))P^{3/2}. (24)

Diffusive Flux.

The dimensionless diffusive flux, S_{D}, is the area average of the normal gradient of the concentration field over the pore, i.e., S_{D}=∫ₚₒᵣₑ (∂c/∂z) dA. Recall from (19) that

$$\frac{1}{π} {\int }_{pore} \frac{\partial {c}_{0}}{\partial z} dA = \frac{π {a}_{0} ( κ )}{2} , \\ \frac{1}{π} {\int }_{pore} \frac{\partial {c}_{1}}{\partial z} dA = \frac{π {{a}_{0} ( κ )}^{2}}{8} .$$

In appendix C2, it is shown that ∫ₚₒᵣₑ(∂c₂/∂z) dA=0 (see eq. (C3)). Similarly, in appendix D2, it is shown that (see eqs. (D5) and (D6))

$$\frac{1}{π} {\int }_{pore} \frac{\partial {c}_{3}}{\partial z} dA = 2 Q ( 1.388 {a}_{0} ( κ ) - 0.462 {a}_{1} ( κ ) ) .$$

Note that the suction flow strength makes an appearance in the expression for the Sherwood number for the first time at O(P). From (E13), (E14a)-(E14b), and (E15) in appendix E2,

$$\frac{1}{π} {\int }_{pore} \frac{\partial {c}_{4}}{\partial z} dA = - \frac{π {a}_{0}^{′} ( κ )}{2} + \frac{1}{2} {Qa}_{0} ( κ ) ( 1.388 {a}_{0} ( κ ) - 0.462 {a}_{1} ( κ ) ) .$$

The spectral coefficients a₀′(κ) and a₀(κ), a₁(κ) are calculated numerically using the method described in appendix E1. The total diffusive component of the Sherwood number is then the sum of the individual contributions at different orders in P.

$${S}_{D} \approx \frac{π {a}_{0} ( κ )}{2} + \frac{π {{a}_{0} ( κ )}^{2}}{8} {P}^{1 / 2} + 2 Q ( 1.388 {a}_{0} ( κ ) - 0.462 {a}_{1} ( κ ) ) P + ( - \frac{π {a}_{0}^{′} ( κ )}{2} + \frac{1}{2} {Qa}_{0} ( κ ) ( 1.388 {a}_{0} ( κ ) - 0.462 {a}_{1} ( κ ) ) ) {P}^{3 / 2} . \qquad ( 25 )$$

From adding the convection and diffusion fluxes (24) and (25), respectively, the final expression for the Sherwood number as a function of the Péclet number, the Damköhler number and the suction strength is in (26a).

$${S}_{spt} ( κ , P , Q ) = \frac{π {a}_{0} ( κ )}{2} + \frac{π {{a}_{0} ( κ )}^{2}}{8} {P}^{1 / 2} + 2 QP + \frac{{a}_{0} ( κ )}{2} {QP}^{3 / 2} - \frac{π {a}_{0}^{′} ( κ )}{2} {P}^{3 / 2} . \qquad ( 26 a )$$

Alternatively, the Sherwood number can be written as

$${S}_{spt} ( P , κ , {P}_{Q} ) = \frac{π {a}_{0} ( κ )}{2} + \frac{π {{a}_{0} ( κ )}^{2}}{8} {P}^{1 / 2} + 2 {P}_{Q} + \frac{{a}_{0} ( κ )}{2} {P}_{Q} {P}^{1 / 2} - \frac{π {a}_{0}^{′} ( κ )}{2} {P}^{3 / 2} . \qquad ( 26 b )$$

The form (26b) allows evaluation of the flux due to a purely suction flow. The O(P) term is a purely suction related term. It indicates that the suction flow transports all the particles in its capture tube into the pore, overwhelming the adsorption mechanics at the pore in the process. There is, however, a coupling between suction and adsorption dynamics at O(P^{3/2}) as reflected in the corresponding term in (26a). With this, the singular perturbation expansion for the Sherwood number as a function of the dimensionless reaction is completed, for vanishingly small shear and suction rates. The O(P^{3/2}) term is aphysical as it is negative and grows large when P>1. Thus the expansion is restricted to O(P),

$${S}_{spt} ( P , κ , {P}_{Q} ) = \frac{π {a}_{0} ( κ )}{2} + \frac{π {{a}_{0} ( κ )}^{2}}{8} {P}^{1 / 2} + 2 {P}_{Q} \qquad ( 26 c )$$

Although the expansion for the extravasation rate is formally valid only for P<<1, we will see that (26c) is surprisingly accurate for a wide range of P, Q and κ. If we use a method of resistances approximation for the shear-Péclet number dependent terms in (26c), then the Sherwood number is expressed as

$${S}_{spt} ( κ , P , Q ) \approx {[ \frac{1}{κ} + \frac{π}{4 {( 1 + 0.3959 {P}^{1 / 2} )}^{2 / 3}} ]}^{- 1} + 2 {P}_{Q} \qquad ( 27 )$$

It is observed that (27) is sufficient to quantify the actual extravasation rate at large values of the Damköhler number, and small values of the suction strength. Therefore (27) captures a lot of the important physics.

### Appendix A: The Inner Expansion Term: c₀

1. Solutions for c₀

The problem is reduced to solving for [symbol] ₀(s) in integral equations corresponding to (10b) and (10c).

$$\begin{matrix}{\int }_{0}^{∞} s {𝒜}_{4} ( s ) {J}_{0} ( s ρ ) ds = 0 , ρ > 1 , & ( A1a ) \\ {\int }_{0}^{∞} ( s + κ ) {𝒜}_{4} ( s ) {J}_{0} ( s ρ ) ds = - κ = {R}_{1} ( ρ ) , 0 < ρ < 1. & ( A1b )\end{matrix}$$

The classical theory of dual integral equations is used, and [symbol] ₀(s) is expressed as a Fourier Cosine transform

$${𝒜}_{0} ( s ) = {\int }_{0}^{1} f ( t ) cos ( st ) dt with f ( 1 ) = 0.$$

This form guarantees that c₀ satisfies the no-flux condition (10c) (equivalently, (A1a)). f(t) satisfies a Fredholm integral equation that is solved spectrally. In particular, express f(t) as a Fourier Sine series in the odd modes and R₁(ρ) as a Fourier-Legendre series.

$$f ( t ) = F ( η ) = {\sum }_{n = 0}^{∞} {a}_{n} sin ( ( 2 n + 1 ) η ) , where t = cos ( η ) , \\ \begin{matrix}{R}_{1} ( ρ ) = \frac{π}{2} {\sum }_{n = 0}^{∞} ( 2 n + 1 ) {g}_{n} {P}_{n} ( 2 {ρ}^{2} - 1 ) , \\ = - κ {P}_{0} ( 2 {ρ}^{2} - 1 ) .\end{matrix}$$

The integral equation (A1b) then reduces to the following infinite set of linear equations in infinite variables that are the undetermined coefficients aₙ.

$${a}_{n} + \frac{κ}{π ( 2 n + 1 )} {\sum }_{m = 0}^{∞} {\sum }_{n = 0}^{∞} {d}_{mn} {a}_{m} = - {g}_{n} , n = 0 , 1 , 2 , …$$

These equations are guaranteed to have a unique solution [26], and are solved numerically by truncating to a suitable number of terms. Using identities for Chebyshev polynomials and Bessel functions, a simplified expression is attained for [symbol] ₀(s)

$${𝒜}_{0} ( s ) = {\sum }_{n = 0}^{∞} {( - 1 )}^{n} ( 2 n + 1 ) π \frac{{a}_{n} ( κ )}{2} \frac{{J}_{2 n + 1} ( s )}{s} .$$

2. Contribution to Sherwood Number from c₀

The diffusive flux due to c₀ is already available in closed form, as seen in (19). The convective contribution to the Sherwood number is then computed as ∫ₚₒᵣₑ−PU_{z}c₀dA. Substitute c₀ from (12) (with z=0) in this equation and recall that U_{S}=(0, 0, −3Q(1−ρ²)^{1/2}) over the pore. Exploiting the axisymmetry in the equations, the integral is simplified as shown below.

$${\int }_{pore} - {PU}_{z} {c}_{0} dA = 2 π {\int }_{0}^{1} 3 {Q ( 1 - {ρ}^{2} )}^{1 / 2} ρ d ρ - {\int }_{0}^{1} 3 {π}^{2} Q {\sum }_{n = 0}^{∞} {( - 1 )}^{n} ( 2 n + 1 ) {a}_{n} ( κ ) [ {\int }_{0}^{∞} \frac{{J}_{2 n + 1} ( s ) {J}_{0} ( s ρ )}{s} {( 1 - {ρ}^{2} )}^{1 / 2} ds ] ρ d ρ .$$

Interchange the order of integration in the first integral of R.H.S above, and use the closed form expression for the resultant inner integral to yield

$${\int }_{pore} - {PU}_{z} {c}_{0} dA = 2 π Q - 3 {π}^{2} Q {\sum }_{n = 0}^{∞} {( - 1 )}^{n} ( 2 n + 1 ) {a}_{n} ( κ ) [ {\int }_{0}^{∞} {J}_{2 n + 1} ( s ) \frac{sin ( s ) - s cos ( s )}{{s}^{4}} ds ] .$$

a₀(κ) is calculated and the integral with respect to s numerically. All the terms except the first two in the summation above are found to be smaller than 10⁻¹² and decay exponentially. Thus, after neglecting all but the first two terms in the summation, an approximate expression for the convection flux due to c₀ is written, given by

$$\frac{1}{π} {\int }_{pore} - {PU}_{z} {c}_{0} dA \approx 2 QP - 2 QP ( 1.388 {a}_{0} ( κ ) - 0.462 {a}_{1} ( κ ) ) . \qquad ( A2 )$$

### Appendix B: The Inner Expansion Term: c₁

1. Contribution to Sherwood Number from c₁

The diffusive flux due to c₁ is also known in closed form, as seen in (19). In a manner similar to the case of c₀, the convective contribution to the Sherwood number is computed as ∫ₚₒᵣₑ−PU_{z}c₁dA. Recall that c₁=B₁c₀ where B₁=A₁πa₀(κ)/4 and A₁=0:318 . . . . Thus, using (A2), the subsequent expression for the convective flux due to c₁ is obtained.

### Appendix C: The Inner Expansion Term: c₂

1. Solution for c₂

The dual integral equations satisfied by the solution form in (21) are first derived. The integral equations are found by enforcing condition (20b) and (20c) on the solution form. Using the cartesian and cylindrical coordinates interchangeably, and with x=ρ cos θ, the dual integral equations are written

$$\begin{matrix}{\int }_{0}^{∞} s {𝒜}_{2} ( s ) {J}_{1} ( s ρ ) ds = 0 , ρ > 1 , & ( C1a ) \\ {\int }_{0}^{∞} ( - s - κ ) {𝒜}_{2} ( s ) {J}_{1} ( s ρ ) ds = κ {B}_{2} ρ , 0 < ρ < 1. & ( C1b )\end{matrix}$$

These equations may be solved simultaneously by methods prescribed by Cooke (supra) and Tranter (supra). We may also cast these equations into an equivalent set of dual integral equations by first integrating, within suitable limits, or differentiating, with respect to ρ, and then using identities for cylindrical Bessel functions. In particular, integrate (C1a) with respect to ρ from 0 to 00 and use the identity for J₁ to formulate an equation in J₀

$${\int }_{0}^{∞} {𝒜}_{2} ( s ) {J}_{0} ( s ρ ) ds = 0 , ρ > 1. \qquad ( C2a )$$

Apply the operator (∂/∂φ(ρ•) to (C1b) and use another identity for J₁ to yield

$${\int }_{0}^{∞} s ( s + κ ) {𝒜}_{2} ( s ) {J}_{0} ( s ρ ) ds = 2 κ {B}_{2} ρ , 0 < ρ < 1. \qquad ( C2b )$$

Again, (C2a) and (C2b) can be solved in principle using methods described in Noble (in Mathematical Proceedings of the Cambridge Philosophical Society, Vol. 59 (Cambridge Univ Press, 1963) pp. 351-362) or fractional integration (A. Erdelyi and I. Sneddon, Can. J. Math 14, 685 (1962)).

2. Contribution to Sherwood Number from c₂

To compute the diffusive contribution of c₂ to Sherwood number, Stoke's theorem on a cuboid region V with surface ∂V having a bottom face centered at origin, and sticking to the wall, are used. The limit as the volume of V approaches infinity is taken.

$$0 = {\int }_{𝒱} {∇}^{2} {c}_{2} dV = {\int }_{\partial 𝒱} \frac{\partial {c}_{2}}{\partial n} dA = {\int }_{bottom} - \frac{\partial {c}_{2}}{\partial z} dA = - {\int }_{pore} \frac{\partial {c}_{2}}{\partial z} dA . \qquad ( C3 )$$

To see why the third equality above holds, notice that c₂ is antisymmetric in x. The flux on the top face in ∂V integrates to 0 while the fluxes on the opposing faces in the shear (x) and vorticity (y) directions cancel each other, leaving out the flux term over the pore.

### Appendix D: The Inner Expansion Term: c₃

1. Solution for c₃

Referring to (22a)-(22d), c₃ is written as a sum of two terms c₁₃ and c₂₃ satisfying (D1a)-(D1e) and (D2a)-(D2d) respectively.

$$\begin{matrix} {∇}^{2} {c}_{13} = z \frac{\partial {c}_{0}}{\partial x} , & ( D1a ) \\ \frac{\partial {c}_{13}}{\partial z} = κ {c}_{13} at z = 0 , ρ \leq 1 , & ( D1b ) \\ \frac{\partial {c}_{13}}{\partial z} = 0 at z = 0 , ρ > 1 , & ( D1c ) \\ {c}_{13} ( r -> ∞ ) \sim {c}_{13}^{∞} ( r ) , & ( D1d ) \\ where {c}_{13}^{∞} = \frac{π {a}_{0} ( κ )}{4} ( - {A}_{2} x ln ( z + r ) + {A}_{3} \frac{xz}{r} - {A}_{4} \frac{x ( {x}^{2} + {y}^{2} - 2 {z}^{2} )}{r ( z + r )} + {A}_{5} x ) & ( D1e ) \\ {∇}^{2} {c}_{23} = {U}_{S} \cdot ∇ {c}_{0} , & ( D2a ) \\ \frac{\partial {c}_{23}}{\partial z} - {U}_{z} {c}_{0} = κ {c}_{23} at z = 0 , ρ \leq 1 , & ( D2b ) \\ \frac{\partial {c}_{23}}{\partial z} = 0 at z = 0 , ρ > 1 , & ( D2c ) \\ {c}_{23} \sim O ( \frac{1}{{r}^{2}} ) as r -> ∞ . & ( D2d )\end{matrix}$$

A boundary integral approach is adopted to solve both sets of equations (D1) and (D2). The standard fundamental solution to Laplace's equation in free-space is used as the symmetric Green's function Gin the formulation, i.e., G(r, r₀)=¼π∥r−r₀∥. Set c₁₃=\tilde{c}₁₃+c₁₃^{∞}. From the nature of the set of equations (D1), it is seen that c₁₃ is antisymmetric in x and symmetric in y, and so is \tilde{c}₁₃. In fact, z(∂c₀)˜O(zx/r³) and ∇²c₁₃^{∞}˜O(x/r²)+O(zx/r³), while (∂c₁₃^{∞}/∂z)|_{z=0}˜x/ρ and ∂c₁₃^{∞}/∂z−κc₁₃^{∞}˜O(x/φ+integrable singularities at r=0. Using Green's identity, the boundary integral equations for \tilde{c}₁₃ is written in a cuboid region V with lower face centered at the origin, and the limit taken as the top face of V approaches infinity. All the surface normals point out of the region.

$${\tilde{c}}_{13} ( r ) - {\int }_{𝒱} G ( r , {r}_{0} ) {∇}^{2} {\tilde{c}}_{13} ( {r}_{0} ) dV = {\int }_{𝒱} ( {\tilde{c}}_{13} ( {r}_{0} ) {∇}^{2} G ( r , {r}_{0} ) - G ( r , {r}_{0} ) {∇}^{2} {\tilde{c}}_{13} ( {r}_{0} ) ) dV , \\ {\tilde{c}}_{13} ( r ) - {\int }_{𝒱} G ( r , {r}_{0} ) ( {z}_{0} \frac{\partial {c}_{0} ( {r}_{0} )}{\partial {x}_{0}} + {∇}^{2} {c}_{13}^{∞} ( {r}_{0} ) ) dV = {\int }_{𝒱} ( {\tilde{c}}_{13} ( {r}_{0} ) \frac{\partial G ( r , {r}_{0} )}{\partial n} - G ( r , {r}_{0} ) \frac{\partial {\tilde{c}}_{13} ( {r}_{0} )}{\partial n} ) dA .$$

Here r₀=(x₀, y₀, z₀) represents the integration variable. The volume integral in the L.H.S above is 0 in the principal value sense as its integrand is antisymmetric in x. In the R.H.S, the principal components of the surface integrals on the pairs of faces perpendicular to shear and vorticity directions cancel each other. The surface integral on the top face decays to 0 in the limit as the top face approaches infinity, as \tilde{c}₁₃ decays to 0 faster than O(1/r²). The integral in the R.H.S is, thus, reduced to the integral on the bottom face on the the wall, and we obtain a solvable equation, in the limit as the volume of V approaches ∞.

$${\tilde{c}}_{13} ( r ) = {\int }_{pore} ( κ {\tilde{c}}_{13} ( {r}_{0} ) G ( r , {r}_{0} ) + singularities ) dA . \qquad ( D3 )$$

In order to show that the set of equations (D2) is solvable, asymptotic analysis is used to establish convergence of the solution to the boundary integral equations. Noting that ∇c₀ and ∥U_{S}∥˜O(1/r²) at r→∞, the following boundary integral equations is obtained over the same cuboid region V that is considered for \tilde{c}₁₃.

$${c}_{23} ( r ) - {\int }_{𝒱} G ( r , {r}_{0} ) O ( \frac{1}{{r}^{4}} ) dV = {\int }_{\partial 𝒱} ( {c}_{23} ( {r}_{0} ) \frac{\partial G ( r , {r}_{0} )}{\partial n} - G ( r , {r}_{0} ) \frac{\partial {c}_{23} ( {r}_{0} )}{\partial n} ) dA .$$

Again, r₀ represents the integration variable. Taking the limit as the volume of V approaches infinity, it is observed that the surface integral term in the R.H.S above is O(1/r⁴), and the surface integral over all faces except the bottom is O(1). Then we obtain a form of a solvable equation for c₂₃, in the limit as the volume of V becomes unbounded.

$${c}_{23} ( r ) - {\int }_{𝒱} G ( r , {r}_{0} ) O ( \frac{1}{{r}^{4}} ) dV = O ( 1 ) + {\int }_{bottom} {c}_{23} ( {r}_{0} ) ( - \frac{\partial G ( r , {r}_{0} )}{\partial {z}_{0}} - κ {1}_{ρ < 1} G ( r , {r}_{0} ) ) dA . \qquad ( D4 )$$

2. Contribution to Sherwood Number from c₃

The diffusive contribution of c₃ to Sherwood number is the sum of the diffusive contributions from c₁₃ and c₂₃. Since c₁₃ is also antisymmetric in x, the same argument is used as in the case of c₂ to show that the diffusive flux due to c₁₃ is 0.

$${\int }_{pore} \frac{\partial {c}_{13}}{\partial z} dA = 0. \qquad ( D5 )$$

The diffusive contribution from c₂₃ is calculated using Stoke's theorem. over a hemispherical region V with the at circular face, ∂V_{f}, centered at the origin and sticking to the wall. The curved surface is denoted by ∂V_{c}. All the surface normals point out of the region. The limit of the integrals is taken as the volume of V approaches infinity.

$${\int }_{𝒱} {∇}^{2} {c}_{23} dV = {\int }_{\partial 𝒱} \frac{\partial {c}_{23}}{\partial n} dA = - {\int }_{\partial {𝒱}_{f}} \frac{\partial {c}_{23}}{\partial z} dA = - {\int }_{pore} \frac{\partial {c}_{23}}{\partial z} dA .$$

The second equality above is seen from the fact that at r→∞, c₂₃˜O(1/r²), and the surface integral over ∂V_{c} approaches 0 in the limit. The last equality is due to the no-flux condition (D2c) on the wall. Using the advection-diffusion equation (D2a) and the fact that Sampson flow is divergence-free, a series of equalities is obtained by applying Stoke's theorem.

$$\begin{matrix}{\int }_{v} {∇}^{2} {c}_{23} dV = {\int }_{v} {U}_{S} \cdot ∇ {c}_{0} dV , \\ = {\int }_{v} ∇ \cdot ( ( {c}_{0} - 1 ) {U}_{S} ) dV , \\ = {\int }_{\partial v} ( {c}_{0} - 1 ) {U}_{S} \cdot ndA , \\ = {\int }_{\partial {v}_{f}} ( 1 - {c}_{0} ) {U}_{s} dA\end{matrix}$$

$$as ( {c}_{0} - 1 ) ∼ O ( \frac{1}{r} ) , ‖ {U}_{S} ‖ ∼ O ( \frac{1}{{r}^{2}} ) and n = - \hat{z} .$$

Using (A2), the above integral is simplified to a closed form given below.

$$\begin{matrix}{\int }_{\partial {v}_{f}} ( 1 - {c}_{0} ) {U}_{s} dA = {\int }_{\partial {v}_{f}} {U}_{s} dA + {\int }_{\partial {v}_{f}} - {c}_{0} {U}_{s} dA , \\ = - 2 π Q + ( 2 π Q - 2 π Q ( 1.388 {a}_{0} ( κ ) - \\ 0.462 {a}_{1} ( κ ) ) ) .\end{matrix}$$

The diffusive flux due to c₂₃ is then given by the negative of the above expression divided by the area of the pore.

$$\frac{1}{π} {\int }_{pore} \frac{\partial {c}_{23}}{\partial z} dA = 2 Q ( 1.388 {a}_{0} ( κ ) - 0.462 {a}_{1} ( κ ) ) . \qquad ( D6 )$$

### Appendix E: The Inner Expansion Term: c₄

1. Solution for c₄

As shown above, c₄=c₄^{∞}+\tilde{c}₄ where \tilde{c}₄=\tilde{c}₁₄+\tilde{c}₂₄+\tilde{c}₃₄+\tilde{c}₄₄. From (23d), c₄^{∞}=B₆(5x²+2y²−7z²) where B₆=−πa₀(κ)A₆/4. Note that ∇²c₄^{∞}=0, (∂c₄^{∞}/∂z)|_{z=0}=0 and c₄^{∞}|_{z=0}=B6(5x²+2y²). Thus, the governing and boundary equations for \tilde{c}₄ are given by

$$\begin{matrix}{∇}^{2} {\tilde{c}}_{4} = ( z \hat{x} + {U}_{S} ) \cdot ∇ {c}_{1} , & ( E1a ) \\ \frac{\partial {\tilde{c}}_{4}}{\partial z} - {U}_{s} {c}_{1} = κ {\tilde{c}}_{4} + {B}_{6} ( 5 {x}^{2} + 2 {y}^{2} ) at \\ z = 0 , ρ \leq 1 , & ( E1b ) \\ \frac{\partial {\tilde{c}}_{4}}{\partial z} = 0 at z = 0 , ρ > 1 , & ( E1c ) \\ {\tilde{c}}_{4} ∼ 0 as r \to ∞ . & ( E1d )\end{matrix}$$

Let \tilde{c}₁₄, \tilde{c}₂₄, \tilde{c}₃₄ and \tilde{c}₄₄ satisfy the following set of equations.

$$\begin{matrix}{∇}^{2} {\tilde{c}}_{14} = z \frac{\partial {c}_{1}}{\partial x} , & ( E2a ) \\ \frac{\partial {\tilde{c}}_{14}}{\partial z} = κ {\tilde{c}}_{14} at z = 0 , ρ \leq 1 , & ( E2b ) \\ \frac{\partial {\tilde{c}}_{14}}{\partial z} = 0 at z = 0 , ρ > 1 , & ( E2c ) \\ {\tilde{c}}_{14} ∼ {\tilde{c}}_{14}^{∞} = - x as r \to ∞ . & ( E2d ) \\ {∇}^{2} {\tilde{c}}_{24} = {U}_{S} \cdot ∇ {c}_{1} , & ( E3a ) \\ \frac{\partial {\tilde{c}}_{24}}{\partial z} - {U}_{z} {c}_{1} = κ {\tilde{c}}_{24} at z = 0 , ρ \leq 1 , & ( E3b ) \\ \frac{\partial {\tilde{c}}_{24}}{\partial z} = 0 at z = 0 , ρ > 1 , & ( E3c ) \\ {\tilde{c}}_{24} ∼ O ( \frac{1}{{r}^{2}} ) as r \to ∞ . & ( E3d ) \\ {∇}^{2} {\tilde{c}}_{34} = 0 , & ( E4a ) \\ \frac{\partial {\tilde{c}}_{34}}{\partial z} = κ {\tilde{c}}_{34} at z = 0 , ρ \leq 1 , & ( E4b ) \\ \frac{\partial {\tilde{c}}_{34}}{\partial z} = 0 at z = 0 , ρ > 1 , & ( E4c ) \\ {\tilde{c}}_{34} ∼ x as r \to ∞ . & ( E4d ) \\ {∇}^{2} {\tilde{c}}_{44} = 0 , & ( E5a ) \\ \frac{\partial {\tilde{c}}_{44}}{\partial z} = κ {\tilde{c}}_{44} + {B}_{6} ( 5 {x}^{2} + 2 {y}^{2} ) at z = 0 , ρ \leq 1 , & ( E5b ) \\ \frac{\partial {\tilde{c}}_{44}}{\partial z} = 0 at z = 0 , ρ > 1 , & ( E5c ) \\ {\tilde{c}}_{44} ∼ 0 as r \to ∞ . & ( E5d )\end{matrix}$$

It is seen that (E3) and (D2) are almost identical set of equations as c₁=Dc₀ (18). Thus, \tilde{c}₁₄=Dc₂₃ where c₂₃ is solved using boundary integral equation (D2). Equations (E4) are very similar to the set of equations (20), and \tilde{c}₁₄ is solved in an identical manner to c₂. More specifically, \tilde{c}₁₄=c₂/B₂. To solve the set of equations (E2) for \tilde{c}₁₄, boundary integral approach is used to solve (D1). Write \tilde{c}₁₄ as a sum of its asymptote and the component decaying to zero, i.e., \tilde{c}₁₄=\tilde{c}₄^{∞}+ĉ₁₄. Note that \tilde{c}₁₄, ĉ₁₄ and z(∂c₁/∂x) are all antisymmetric in x, while ∇²c₁₄^{∞}=0, (∂c₁₄^{∞}/∂z)|_{z=0}=0, and [symbol] ₁₄^{∞}/∂z−κ\tilde{c}₁₄˜O(x) at the pore. As shown next, solvable boundary integral equations for ĉ₁₄ is obtained using the fundamental solution G (r, r₀)=¼∥r−r₀∥.

$${\tilde{c}}_{14} ( r ) = {\int }_{pore} κ {c}_{14} ( {r}_{0} ) G ( r , {r}_{0} ) dA . \qquad ( E6 )$$

After determining a method to solve for each of \tilde{c}₁₄, \tilde{c}₂₄ and \tilde{c}₃₄, the set of equations (E5) for \tilde{c}₄₄ is solved. Let the boundary conditions (E5b) be rewritten using cylindrical coordinates.

$$\frac{\partial {\tilde{c}}_{44}}{\partial z} = κ {\tilde{c}}_{44} + \frac{7}{2} κ {B}_{6} {ρ}^{2} + \frac{3}{2} κ {B}_{0} {ρ}^{2} cos ( 2 θ ) at z = 0 , ρ \leq 1.$$

\tilde{c}₄₄ is further decomposed into two parts: ĉ₄₄₁ and ĉ₄₄₂ that are solved individually using the theory of dual integral equations. They satisfy the equations given next.

$$\begin{matrix}{∇}^{2} {\tilde{c}}_{441} = 0 , & ( E7a ) \\ \frac{\partial {\tilde{c}}_{441}}{\partial z} = κ {\tilde{c}}_{441} + \frac{3}{2} κ {B}_{6} {ρ}^{2} cos ( 2 θ ) at z = 0 , ρ \leq 1 , & ( E7b ) \\ \frac{\partial {\tilde{c}}_{441}}{\partial z} = 0 at z = 0 , ρ > 1 , & ( E7c ) \\ {\tilde{c}}_{441} ∼ 0 as r \to ∞ . & ( E7d ) \\ {∇}^{2} {\tilde{c}}_{442} = 0 , & ( E8a ) \\ \frac{\partial {\tilde{c}}_{442}}{\partial z} = κ {\tilde{c}}_{442} + \frac{7}{2} κ {B}_{6} {ρ}^{2} at z = 0 , ρ \leq 1 , & ( E8b ) \\ \frac{\partial {\tilde{c}}_{442}}{\partial z} = 0 at z = 0 , ρ > 1 , & ( E8c ) \\ {\tilde{c}}_{442} ∼ 0 as r \to ∞ . & ( E8d )\end{matrix}$$

As ĉ₄₄₁ and ĉ₄₄₂ satisfy the Laplace's equation, they can be expressed in cylindrical harmonic form shown in (E9a) and (E9b).

$$\begin{matrix}{\tilde{c}}_{442} = {\int }_{0}^{∞} {𝒜}_{3} ( s ) {e}^{- π 2} {J}_{2} ( s ρ ) cos ( 2 θ ) ds , & ( E9a ) \\ {\tilde{c}}_{442} = {\int }_{0}^{∞} {𝒜}_{4} ( s ) {e}^{- π 2} {J}_{0} ( s ρ ) ds , & ( E9B )\end{matrix}$$

Enforcing the boundary conditions on these forms provide us with a pair of integral equations each, in [symbol] ₃ (s) and [symbol] ₄ (S). In particular, ĉ₄₄₁ satisfies

$$\begin{matrix}{\int }_{0}^{∞} s {𝒜}_{3} ( s ) {J}_{2} ( s ρ ) ds = 0 , ρ > 1 , & ( E10a ) \\ {\int }_{0}^{∞} ( s + κ ) {𝒜}_{3} ( s ) {J}_{2} ( s ρ ) ds = - \frac{3}{2} κ {B}_{6} {ρ}^{2} , 0 < ρ < 1. & ( E10b )\end{matrix}$$

Similarly, ĉ₄₄₂ simultaneously satisfies the pair of integral equations given below.

$$\begin{matrix}{\int }_{0}^{∞} s {𝒜}_{1} ( s ) {J}_{0} ( s ρ ) ds = 0 , ρ > 1 , & ( E11a ) \\ {\int }_{0}^{∞} ( s + κ ) {𝒜}_{4} ( s ) {J}_{0} ( s ρ ) ds = - \frac{7}{2} κ {B}_{6} {ρ}^{2} , 0 < ρ < 1. & ( E11a )\end{matrix}$$

Equations (E10a)-(E10b) and (E11a)-(E11b) may be solved formally using a variety of methods proposed by Cooke (supra) and Tranter (supra), and Erdelyi and Sneddon (supra), among others. Care must be taken to ensure that the formal solutions converge. (E10a)-(E10b) may also be cast into integral equations in J₀ using identities for cylindrical Bessel functions, as done with (C1a)-(C1b) in appendix C1.

For the sake of utility of the explicit solution form in appendix E2, (E11a)-(E11b) are solved here spectrally, in a manner similar to solving for [symbol] ₀(s) in appendix A1. Let R₂(ρ)=−(7/2)κB⁶ρ². Also let

$${𝒜}_{4} ( s ) = {\int }_{0}^{1} h ( t ) cos ( s t ) dt , h ( 1 ) = 0.$$

Following the same steps as in the case of c₀, write h(t) as a Fourier Sine series in the odd modes and R₂(ρ) as a Fourier-Legendre series

$$h ( t ) = H ( η ) = {\sum }_{n = 0}^{∞} {a}_{n}^{′} sin ( ( 2 n + 1 ) η ) , where t = cos ( η ) , \\ \begin{matrix}{R}_{2} ( ρ ) = \frac{π}{2} {\sum }_{n = 0}^{∞} ( 2 n + 1 ) {g}_{n} {P}_{n} ( 2 {ρ}^{2} - 1 ) , \\ = \frac{π}{2} ( \frac{- 7 κ {B}_{6}}{2 π} {P}_{0} ( 2 {ρ}^{2} - 1 ) + \frac{- 7 κ {B}_{6}}{2 π} {P}_{1} ( 2 {ρ}^{2} - 1 ) ) .\end{matrix}$$

The integral equation (E11b) reduces to the following infinite set of linear equations in infinite variables that are the undetermined coefficients aₙ′

$${a}_{n}^{′} + \frac{κ}{π ( 2 n + 1 )} {\sum }_{m = 0}^{∞} {\sum }_{n = 0}^{∞} {d}_{mn} {a}_{m}^{′} = - {g}_{n} , n = 0 , 1 , 2 , … .$$

The analytical form for ĉ₄₄₂ is then given by

$${\tilde{c}}_{442} = \frac{π}{2} {\sum }_{n = 0}^{∞} {( - 1 )}^{n} ( 2 n + 1 ) {a}_{n}^{′} {\int }_{0}^{∞} \frac{1}{s} {e}^{- sz} {J}_{2 n + 1} ( s ) {J}_{0} ( s ρ ) ds . \qquad ( E12 )$$

2. Contribution to Sherwood Number from c₄

The diffusive contribution to the Sherwood number from \tilde{c}₁₄ is found to be 0 using Stoke's theorem and the fact that \tilde{c}₁₄ is antisymmetric in x. The argument is a repeat of that made for c₂ in appendix C2. Similarly, the diffusive flux averaged over due to \tilde{c}₃₄ is also 0. Except for a scaling factor of B₁=A₁πa₀(κ)/4, \tilde{c}₂₄ satisfies the same set of equations as c₂₃. Thus, their respective diffusive fluxes are also related by the same scaling factor,

$$\frac{1}{π} {\int }_{pore} \frac{\partial {\tilde{c}}_{24}}{\partial z} dA \approx 0.5 {Qa}_{0} ( κ ) ( 1.388 {a}_{0} ( κ ) - 0.462 {a}_{1} ( κ ) ) . \qquad ( E13 )$$

In the case of ĉ₄₄₁, due to the cosine term in (E9a), the diffusive flux over the pore again integrates to 0, as shown below.

$$\frac{1}{π} {\int }_{pore} \frac{\partial {\hat{c}}_{441}}{\partial z} dA = \frac{1}{π} {\int }_{0}^{2 π} {\int }_{0}^{1} {\int }_{0}^{∞} ( - s ) {𝒜}_{3} ( s ) {e}^{- sz} {J}_{2} ( s ρ ) ds ρ d ρ cos ( 2 θ ) d θ = 0. \qquad ( E14a )$$

As ĉ₄₄₂ is a harmonic function with far-field behavior ˜πa₀′(κ)/4r, its area averaged diffusive flux is calculated using Stoke's theorem (similar to the case of c₀) and found to be

$$\frac{1}{π} {\int }_{pore} \frac{\partial {\hat{c}}_{442}}{\partial z} dA = - \frac{π {a}_{0}^{′} ( κ )}{2} . \qquad ( E14b )$$

Lastly, the diffusive flux due to c₁₄ is

$$\frac{1}{π} {\int }_{pore} \frac{\partial {c}_{4}^{∞}}{\partial z} dA = \frac{1}{π} {\int }_{pore} - 2 {B}_{6} z {\vert}_{z = 0} dA = 0. \qquad ( E15 )$$

### EXAMPLES

The following examples are put forth so as to provide those of ordinary skill in the art with a complete disclosure and description of how to make and use the disclosed subject matter, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations may be used, e.g., bp, base pair(s); kb, kilobase(s); pl, picoliter(s); s or sec, second(s); min, minute(s); h or hr, hour(s); aa, amino acid(s); kb, kilobase(s); bp, base pair(s); nt, nucleotide(s); i.m., intramuscular(ly); i.p., intraperitoneal(ly); s.c., subcutaneous(ly); and the like.

### Example 1: Brownian Dynamics (BD) for Point Particles

BD simulations for a large range of P, κ and Q were performed. The simulation domain, as shown in FIG. 5, is a box of dimensionless size L₁×L₂×L₃=60×60×30. The bottom face is a rigid wall with a circular pore of unit radius. A large number of Brownian particles were introduced into the box randomly distributed, and a shear flow superposed with a Sampson flow (3a) were applied. The equations of motion of Lagrangian particles distributed in the simulation domain were evolved. The Langevin equations of motion in the dimensionless form were as follows.

dx=PU(x)dt+d [symbol] (28)

Here d [symbol] was the Wiener process which, in the context of simulation, can be interpreted as a vector of independent Gaussian random variables N with zero mean and variance 2dt. The notation of the Ito equation (28) was overloaded, so that dt was the size of the simulation time step, the change in position vector was denoted by dx, and U was the flow velocity (3a). A particle trajectory simulated in this manner could have eventually hit the floor of the domain at x₃=0. Depending on the location of the hit, the trajectory underwent a reflection (collision with the wall) or a partial reflection (occasional adsorption at the pore).

The partial reflection process was associated with a reflection probability that depended on the time step dt and the reaction rate κ and the suction strength Q. This relation between the reaction constant in a Robin boundary and the reflection probability was first well defined by Singer et al. (SIAM Journal on Applied Mathematics 68, 844 (2008)). For trajectories that cross the boundary, identified by the condition z+PU_{z}dt+\sqrt{2dt}N_{z}<0, the new coordinate position z₀ was obtained as

$${z}^{′} = \{ \begin{matrix}- ( z + {PU}_{z} dt + \sqrt{2 dt} {N}_{z} ) , \\ with probability 1 - κ \sqrt{π dt} . \\ 0 i . e , terminate trajectory otherwise\end{matrix} \qquad ( 29 )$$

If the trajectory was terminated, the particle was reintroduced at the top face of the domain. This ensured constant flux at the top distributed over a large area and conserved the total number of particles in the simulation domain. Any particle that moved above and beyond the top face as reintroduced in the domain at a random location near the top face. The simulation domain was periodic in the flow and vorticity directions, parallel to the plane of the bottom face.

The particle trajectory and the number of particles exiting the pore over time were tracked. The flux across the pore by calculating the time derivative of this number, normalized by the far-field concentration of particles were determined.

It should be noted that the flux from the simulations was computationally sensitive to the method of calculating the normalization concentration. Typically, the normalization concentration was calculated by counting the number of particles in the top 70% of the simulation box and dividing by the volume. Simulation results also had small errors related to the sudden change in boundary condition at the pore edge. These errors could be controlled by making the time step small.

Simulations were performed for Péclet numbers ranging from 0 to 100 and for Damköhler numbers ranging from as small as 0:1 to as large as 300. The simulation was performed with a time step dtε{1e−3, 1e−4} and simulation was performed until t=100, with the flux calculated over the last two-thirds of the interval where a steady flux was observed. Simulations were also performed for varying suction strength Q. 400,000 particles were used in each simulation. Since each particle moved without interaction with other particles, the extravasation rate was obtained by ensemble averaging over 10 simulations. In the following section, the extravasation rates from BD to those predicted by the analytical result (27) were compared.

### Comparison Between BD and SPT

The three dimensionless numbers P, κ, and Q completely determine the extravasation rate. Two cases were investigated. The first was an exploration of the effect of shear flow and resistance at the pore on the flux to the pore. The second case was regarding the effect of suction on the flux.

1. The Effect of Péclet Number P and Damköhler Number κ

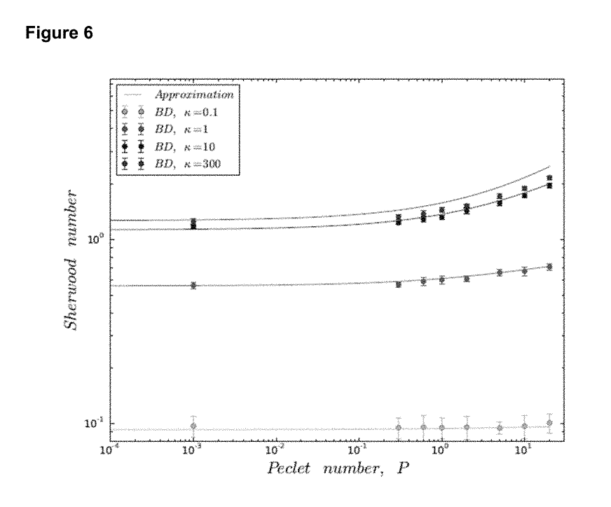

FIG. 6 depicts the variation in the Sherwood number as the Péclet number was increased for a constant Damköhler number. The Damköhler number was limited to a maximum of 300 because the Sherwood number asymptotically approached a constant value as κ became large. The analytical result (27) with Q=0 was validated using accurate boundary element simulations as well as the singular perturbation theory of Shah et al. (supra). Some of the important observations will be revisited via the means of BD simulations. It is noted that the BD simulations correctly predicted the Sherwood number (27) even when P=O(10). At sufficiently large Péclet number, it was expected that the BD results would deviate from (27) as a periodic system of pores enforced by the periodic boundary conditions were effectively simulated. The deviation could be reduced by increasing the size of the periodic box.

FIG. 6. The Sherwood Number Vs Péclet Number Plotted for κε0. 1, 1, 10, 300.

The continuous line (-) is the perturbation result (27), and the filled circles () with error bars are the BD results.

After validating the BD simulations and singular perturbation theory, a few observations were made about the general trends in the Sherwood number for all value of K. From FIG. 6, it can be seen that at any fixed Damköhler number κ, the Sherwood number increased with increasing Péclet number. At P<<1, diffusion dominated the bulk physics and the growth in extravasation rate was quite slow. Up to large values of Péclet number (P=O(10)), the Sherwood number showed the P^{1/2} power law dependence. At very large Péclet numbers (P=O(100)), the mass transport boundary layer over the pore was fully developed and the Sherwood number was expected to have the well-known P^{1/3} power law dependence associated with the Graetz Lévêque boundary layer. This gradual change in scaling of the Sherwood number with the Péclet number was explained by the following argument. As the Péclet number increased, more number of particles per unit time were exposed to the adsorption surface, and every particle was exposed to a larger surface area per unit time, thus leading to a net increase in the extravasation rate.

To gain more insight into the nature of the Sherwood number, the Péclet number (with Q=0) was fixed and the Sherwood number (27) was observed to be bounded by two asymptotes at the two extremes of the range of κ. As explained in Shah et al. (supra), for small values of the Damköhler number, the reaction (adsorption) process dominated any other physical process near the pore. Then, the Sherwood number was bounded above by and asymptotically approached the rate of reaction (adsorption) at vanishing κ (S≈κ). At large values of κ, the Sherwood number asymptotically approached an upper bound (4/π)(1+0.3959P^{1/2})^{2/3} that depended only the Péclet number. Note that the slight discrepancy between the values of the Sherwood number from SPT and BD simulations when κ=300 could be reduced by using an even smaller time-step. Overall, the BD simulation was able to predict the Sherwood number correctly in the regime that encompassed the physiologically relevant values of κ and P.

2. The Effect of Suction Flow Strength Q

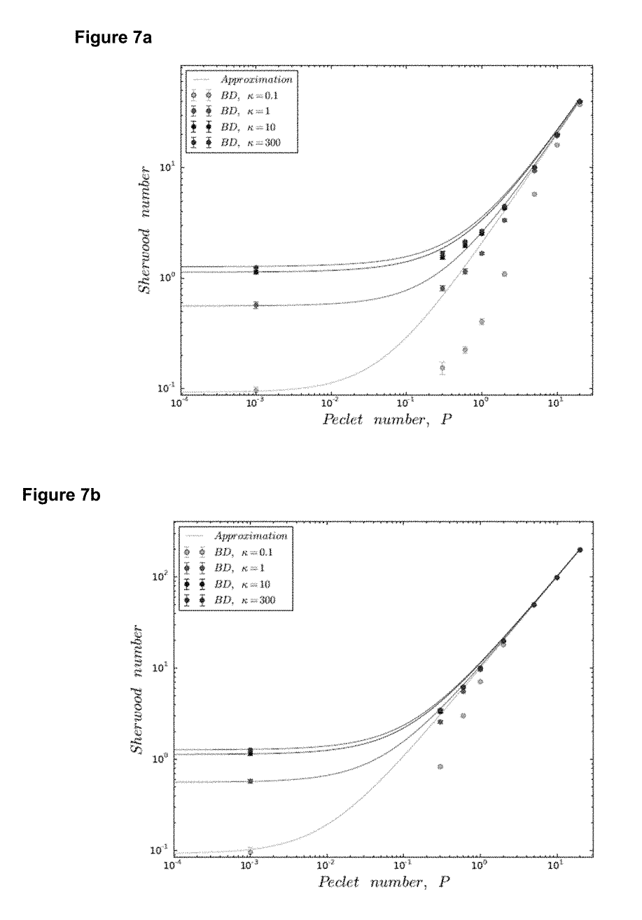

The physics when a suction flow is introduced in the mass transport problem is now examined. BD simulations were relied on to capture the effect of additional the suction flow field. With accurate BD simulations the extravasation rate of particles in the presence of a pressure driven suction flow was predicted and compared with that predicted by the theory of (27). The comparison is shown in FIGS. 7a and 7b for two different suction strengths: Q=1 and Q=5, representing moderate and large values of Q respectively. The Damköhler number can also be varied, so FIGS. 7a and 7b are the same as FIG. 6 but for different suction strengths. It was observed that there was a rather good agreement between the predictions for the Sherwood number by SPT (27) and BD simulations for a wide range of values of P,Q when the Damköhler number was large. A striking aspect of (27) was the O(P) term, 2P_{Q}=2QP, through which the suction strength Q effected the Sherwood number. Once the suction strength or the shear Péclet number became adequately large, the O(P) term in (27) dominated the lower order terms at any κ, as mirrored by the linear profiles on the log scale in each of FIGS. 7a and 7b. In short, the suction based Péclet number P_{Q} completely determined the influence of suction at large values of P_{Q}. It is intriguing that the suction strength had a linear effect on the Sherwood number, independent of the value of the Damköhler number at sufficiently large values of P_{Q}. This could be traced to the phenomenon of capture tube, which is explained next. It was observed that the Sampson flow field was axisymmetric and supplied all the fluid that was sucked into the pore. When a shear flow was superimposed, the flow streamlines separated into two fluid regions. The streamlines that entered the pore lay inside a tube-like surface upstream of the pore and slowly increased in cross-sectional area with distance from the pore (see FIG. 4). All the fluid inside this tubular surface was captured by the pore. Recall that PU_{z}=−3Q(1−ρ²)^{1/2} over the pore (ρ<1). Thus, total flow rate through the pore was 2πQP, and the area-averaged flow rate through the pore was 2QP. Since the suspension of point particles was dilute they advected along streamlines inside the capture tube when the Péclet number was large i.e., a large pressure gradient was present driving the flow into the pore. The normalized flux of particles transported by the capture tube was then 2PQ, which was exactly the O(P) term. In addition, a diffusion process transporting particles from the bulk to the pore at a rate equal to the first two terms in (27) was present. As remarked upon before, an interesting feature of this process is that κ became irrelevant at large values of P_{Q}. This was because physically, suction and reaction were competing processes at the pore. Then, for a sufficiently large suction Péclet number, the suction flow inside the capture tube overwhelmed the reaction mechanism and a nearly reaction independent flux was obtained. At small values of P_{Q}, the reaction at the pore had a more pronounced effect on the Sherwood number as seen in the region of P˜O(1) in FIGS. 7a and 7b. It was also expect that SPT would be in weak agreement with the BD simulations in this regime of the Péclet number where particles may diffuse out of the capture tube in large quantities. This explained the mismatch around P=1 in the predictions of SPT and BD in FIGS. 7a and 7b.

FIGS. 7a and 7b. The Sherwood Number Vs Péclet Number Plotted for κε0. 1, 1, 10, 300.

The continuous line (-) is the perturbation result (27), and the filled circles () with error bars are the BD results.

It was demonstrated that (27) is a great approximation when Q=0 for all values of the Péclet and Damköhler numbers. When suction was present, (27) was still a good approximation when κ>>1. At smaller values of the Damköhler number and at finite but small suction strength Q, it was observed that the SPT over-predicts the Sherwood number since it was unable to account for the small reaction rate. However, as the suction Péclet number increased, the Sherwood number grew asymptotically as 2 P_{Q} independent of the Damköhler number. Thus, while (27) was not valid at all parameter regimes, it was still useful in understanding the qualitative trends and effects of the various dimensionless parameters.

### Example 2: Brownian Dynamics (BD) for Finite Sized Particles

BD simulation for point particles was a Lagrangian particle simulation. As remarked before, it could be easily extended to model physics such as external force fields, electrostatic interactions, etc. One could also model motion of arbitrary shaped finite size particles. Thus, the BD algorithm of the point particles of Example 1 was modified to model the motion of general spheroids. The basic algorithm was again to calculate the configuration of a suspension of Brownian particles as it evolved in each time step in a shear+suction flow. Each spheroidal particle has a center of mass vector x and an orientation vector p associated with it. The orientation vector pointed in the direction of the principal axis. For a spheroid of radius r and semi-length t along the principal axis, the aspect ratio (ε) was defined ε=min{r,t}/max{r,t} and an eccentricity e=\sqrt{1−ε²}. Spheroidal particles have anisotropic diffusivity that depends on the eccentricity and the aspect ratio and thus, interact with flow differently than spherical particles. Both prolate and oblate spheroids have greater tendency to diffuse along their longer dimension as compared to perpendicular to it. In particular, in the limit as the aspect ratio of a prolate spheroid becomes large, the slender body model of a rod-like particle was approached. Similarly, in the case of oblate spheroid, the limit ε=0 corresponded to a flat disk-like geometry. Thus, our BD algorithm modeled a wide variety of axisymmetric shapes ranging from thin needle-like particles to flat discoid geometries geometries. The anisotropic diffusivity of general spheroids were decomposed into a “parallel diffusivity” D_{∥} in the direction of the principal axis and a “perpendicular diffusivity” D_{⊥} in the cross-sectional plane perpendicular to the orientation of the particle.

$$\begin{matrix}D = {D}_{⊥} ( I - pp ) + {D}_{∥} pp , & ( 30 a ) \\ where {D}_{⊥} = \frac{{k}_{B} T}{6 πμ a {β}_{0} {Y}^{A}} , {D}_{∥} = \frac{{k}_{B} T}{6 πμ a {β}_{0} {X}^{A}} . & ( 30 b )\end{matrix}$$

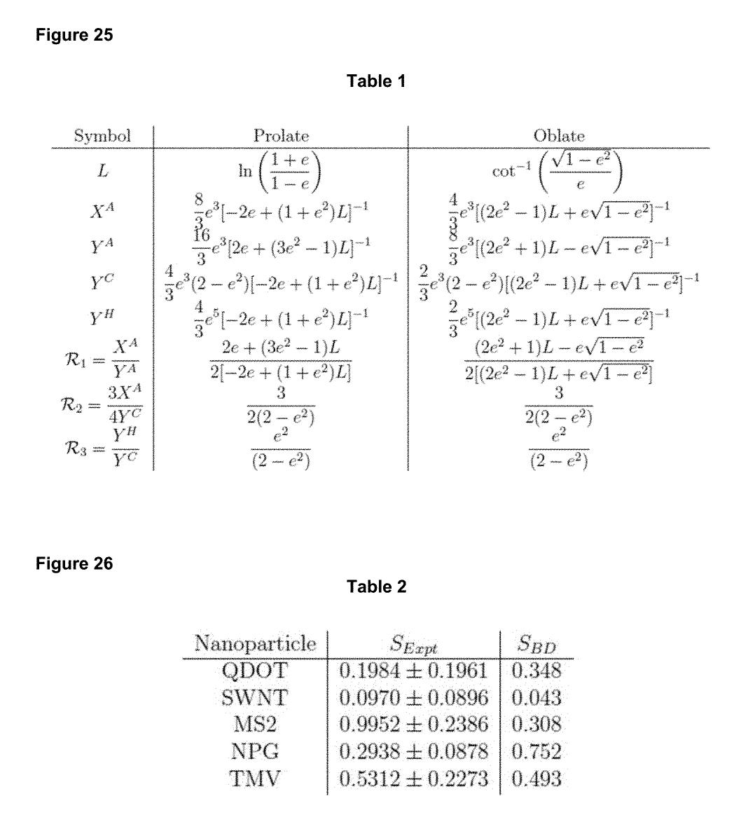

Here k_{B} was the Boltzmann constant, μ was the fluid viscosity, and T was the fluid temperature. The ratio of the maximum dimension of the spheroid to the pore diameter was defined as β₀=max{r,t}/a. The values of X^{A}; and Y^{A} for both prolate and oblate spheroids are shown in Table I of FIG. 25. For spherical particles, X^{A}=Y^{A}=1 and the Stokes-Einstein isotropic diffusivity is recovered. For prolate spheroids, in the limit as ε→0, the slender body diffusivities for rod-like fibers were recovered:

$${D}_{⊥} = \frac{{k}_{B} Tln ( 1 / ε )}{8 πμ t} , {D}_{∥} = \frac{{k}_{B} Tln ( 1 / ε )}{4 πμ t} .$$

The extravasation process occurs on the diffusion time scale based on translational diffusivity. For this purpose, the Péclet number was defined using a mean translational diffusivity which was calculated as an average of the translational diffusivity over all orientations. A constant factor f which was the ratio of the mean translational diffusivity to the diffusivity along the orientation direction, was introduced, as described below.

$$D = {fD}_{∥} , f = \frac{1}{3} + \frac{2}{3} \frac{{D}_{∥}}{{D}_{⊥}} , P = \frac{\dot{γ} {B}^{2}}{D} . \qquad ( 30 c )$$

FIG. 25.

Table I: Geometric factors for prolate and oblate spheroids that appear in the diffusion coefficients (30a) and equations of motion (31) and (32).

Spheroids also undergo a rotational diffusion i.e., the orientation vector p undergoes diffusion in the orientation space which is the surface of the unit sphere in [symbol] ³. The rotational diffusivity was given by

$${d}_{r} = \frac{{k}_{B} T}{8 πμ {a}^{3} {β}_{0}^{3} {Y}^{C}} , \qquad ( 30 d )$$

where Y^{C} was tabulated for prolate and oblate shapes in Table I (FIG. 25). A rotational diffusion based Péclet number Pᵣ was also defined, as described in (30e) below. A suction and rotational diffusion based Péclet number P_{Qr} was also defined.

$${P}_{r} = \frac{\dot{γ}}{{d}_{r}} , {P}_{Qr} = {QP}_{r} . \qquad ( 30 e )$$

The dimensionless equations of motion were obtained by inverting the equations for drag force and torque on a general spheroid translating and rotating about its center of mass through a local background flow U and vorticity Ω. To model the thermally induced diffusion of the spheroid, anisotropic diffusion terms were added in the equation of motion for the center of mass. Similarly, a diffusion term was added to the orientation evolution equation which was isotropic on the surface of a sphere (more accurately, uniformly distributed in the space of quarternions). This lead to the Langevin equation for the stochastic motion of these particles.

$$\begin{matrix}dx = PUdt + {( \frac{1}{f} )}^{1 / 2} ( pp + {ℛ}_{1}^{1 / 2} ( I - pp ) ) \cdot d 𝒩 , & ( 31 ) \\ dp = P ( Ω p + {ℛ}_{3} ( I - pp ) \cdot E \cdot p ) dt + \frac{1}{{β}_{0}} {( \frac{{ℛ}_{2}}{f} )}^{1 / 2} d ℳ . & ( 32 )\end{matrix}$$

The factors β₀, and [symbol] _{1,2,3} (see Table I (FIG. 25)) were geometric factors that arose out of non-dimensionalization of the equations of motion using the time scale based on orientation-averaged diffusivity and the length scale equal to the pore radius. As in Example 1, d [symbol] could be viewed as a vector of normal random variables with zero mean and variance 2dt. Similarly, d [symbol] was the Brownian process on the surface of the unit sphere in [symbol] ³ and could be modeled by random walk steps executed by the orientation vector on the unit sphere. These steps were in sampled from a vector of Gaussian distribution of zero mean and variance 2dt and projected.

Since the algorithm was the same for each particle, the following discussion is on a per-particle basis. Due to the finite size of particles, a region of excluded volume surrounding the wall and pore was implemented. The excluded volume interaction was modeled by elastic collision between the particle and the domain boundaries. For this a collision detection algorithm was implemented, where the spheroidal surface were represented by a point cloud. In each time step, the intersection of the straight-line trajectory was detected from before-to-after location of each point of this cloud. By design, the before location for each point in the cloud was always inside the simulation domain while the after location may not have been always inside, indicating collision. The point of minimum distance on the particle from the simulation domain (and thus, also the surface normal at the point) was identified. A bisection search on this minimum distance for collision detection was performed while the particle executed a rigid body motion from initial configuration to its final configuration for the time step. Taking advantage of the symmetries in the spheroidal geometry it was possible to write a simple formula to implement elastic collision to obtain a reflected trajectory. Collision on this reflected trajectory was tested as well, as there could be multiple collisions during one time step.

In the statistical mechanical sense, excluded volume interaction that models steric effects basically restricted the phase space of the N-particle configuration vector (x₁, p₁ . . . , x_{N}, p_{N}) so that some regions of the phase were inaccessible for any system trajectory. As long as the system configuration spent most of the time away from these inaccessible regions, any reasonable implementation of the excluded volume would have been valid. For example, it would have been possible to implement an artificial collision force between the representative point clouds of each particle and the simulation domain boundary. This artificial force would have contributed a net force and a torque term in the equations of motion (31) and (32) that would have been large when the particle was close to the domain boundary. It was assumed that because of the finite size of the particle and the circular geometry of the pore, the steric effects must dominate the lubrication interactions between the pore and the particles.

The adsorption/reaction dynamics for finite sized particles is the same as that for point particles in Example 1. However, note that the pore were now modeled as a cylindrical tube with a finite length and a particle was allowed to be adsorbed at the bottom end of this tube. The length of this tube was a simulation parameter that was chosen to be half the maximum dimension of the particles in this work. Physically this corresponded to the case where at least half the volume of the particle was inside the pore. This allowed, then, comparison between the Sherwood numbers for the different particles.

An ensemble of at least 10 simulations were simulated for 4e+5 particles with a dimensionless time step of 4e-4 and a total duration of 100 time units. After setting the values of P, Q and choosing the dimensionless sizes α, β for the spheroidal geometry, the Sherwood number is calculated as the mean of the Sherwood numbers obtained in each of the simulations in the ensemble. Again, note that the standard deviation could be reduced by choosing a small time step or increasing the number of particles or the number of ensembles. The inherent accuracy of the simulation results could also be improved by reducing the time step. The standard deviation observed for any data point in the simulation was usually less than 5%.

### Flux of Finite Sized Particles

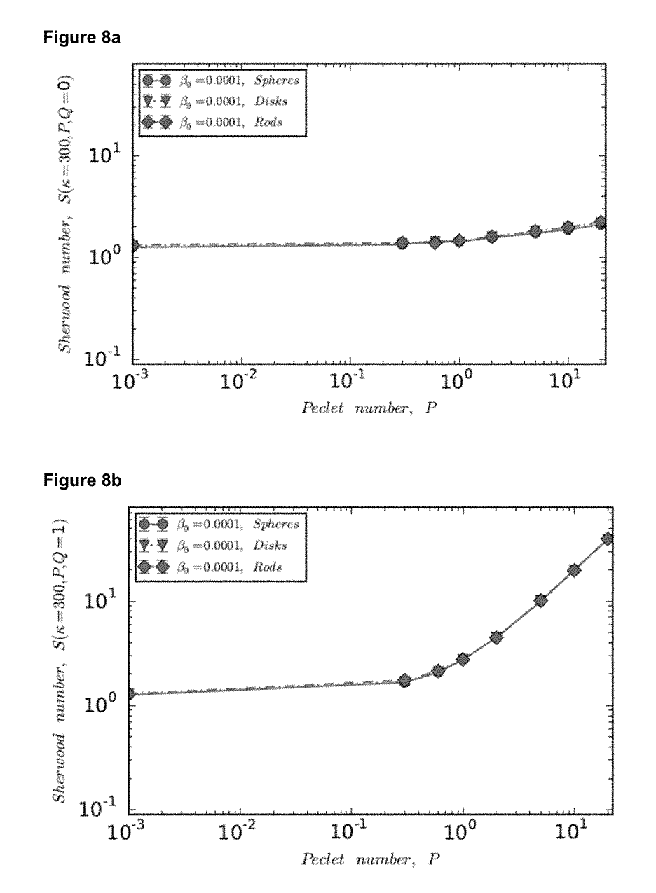

Simulation results for the Sherwood number for three representative particle geometries were obtained: (i) spherical (ε=1), (ii) slender rod-like (ε=0:1), and (iii) discoid (ε=0:1). These geometries will be referred to in short by ‘spheres’, ‘rods’, and ‘disks’, respectively. The Péclet number took values from 0 to 20 and Qε{0,1}. The Damköhler number was fixed to κ=300 as the trends were qualitatively similar for any Damköhler number. The influence of size, shape (aspect ratio) and suction strength on the Sherwood number will be discussed. First, the BD simulations were consistent with the results for the point-particles in the limit as the particle size was made small. FIGS. 8a and 8b show the comparison between the Sherwood numbers as predicted for the three particle shapes with largest dimension β₀=0.0001. The Sherwood numbers predicted for the three shapes were close to the results for point particles. This was because small particles had very small rotational diffusion time scale, which nullified the advantage of enhanced directional diffusion. It was concluded that the BD simulations for finite sized particles were consistent with the BD simulations of Example 1.

FIGS. 8a and 8b.

The Sherwood number predicted by BD simulation is plotted vs the Péclet number for small spheres, rods, and disks, to show that they have the same point-particle flux.

1. The Effect of Size

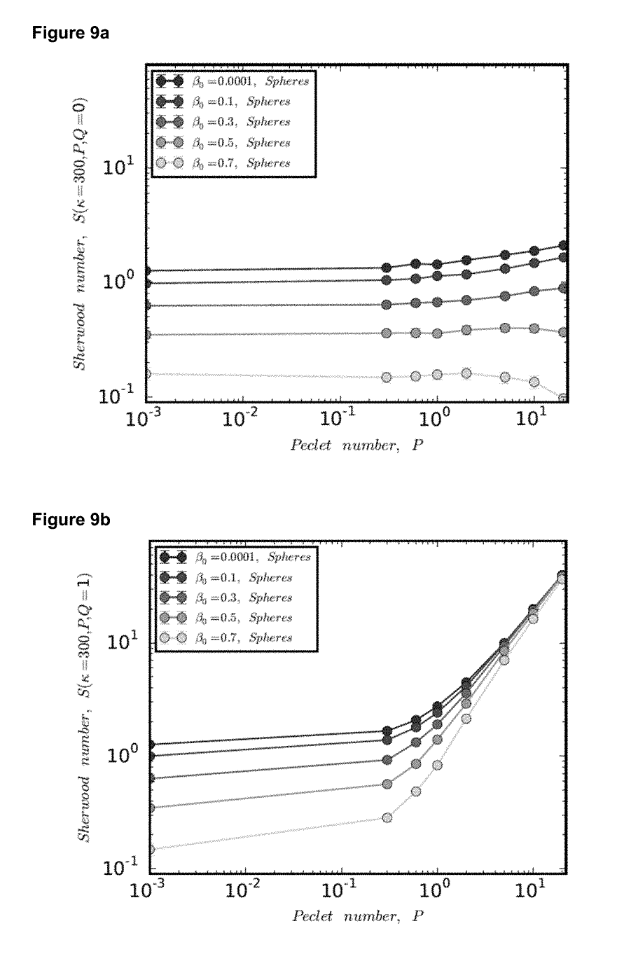

Spherical particles. A spherical particle of a finite size diffused through a smaller cross-sectional area of the pore, which restricted the flux as compared to the case of point particles. It is evident from FIGS. 9a and 9b that as the sphere size increased relative to pore radius, the Sherwood number for any fixed P reduced in magnitude. In FIGS. 9a and 9b, the point particle limit was β₀=0.0001. The largest spherical particle that was simulated was of size β₀=0:7. These results can easily be extrapolated to see that a sphere of the same size as the pore will have almost zero flux. Note that the statistical variation in the data presented was within the standard deviation.

FIGS. 9a and 9b.

The Sherwood number predicted by BD simulation is plotted vs the Péclet number for various dimensionless sizes β₀=r/a) of spherical particles.

When suction flow was absent, the augmenting effect of shear rate (through the Péclet number) was not present for larger particles. That is, the Sherwood number increased weakly with the Péclet number with increasing particle size. Then, in the case of large spherical particles, diffusion was the dominant process at physiologically relevant values of P. For very large particle sizes, a strong shear transported the particle away from the pore while it was sterically hindered. However, even a mildly strong suction flow (Q=1) drove a noticeable flux for all particle sizes (see FIG. 9b). It was observed that the linear profiles associated with the 2QP term, which supported the theory.

Rod Shaped Particles.

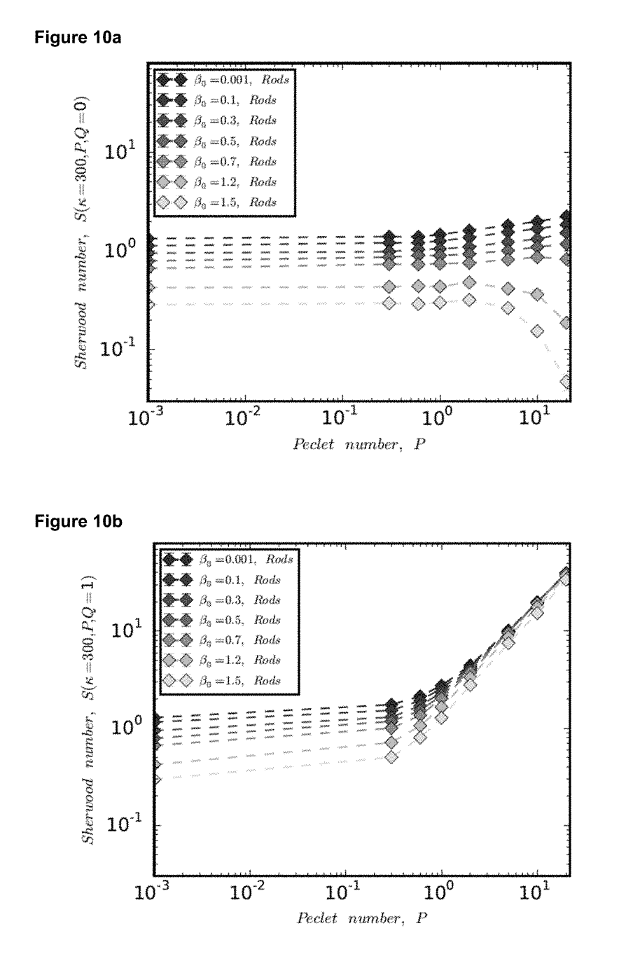

The flux data for rod shaped particles is shown in FIGS. 10a and 10b. The case β₀=0.0001 corresponded approximately to the point particle limit. The extravasation rate of rod shaped particles was qualitatively similar to the case of spherical particles. For example, in the case of purely linear shear flow (Q=0), it was evident from FIG. 10a that the Sherwood number was smaller for larger rod lengths. Similarly, the Sherwood number increased weakly with the Péclet number as particle length increased. Just as spheres, rod shaped particles experienced a reduced flux at larger Péclet numbers. This may be explained by the fact that the spheroid undergoes rotational motion under shear, which allowed it to enter the pore at oblique angles, in turn allowing the particle to get captured. At large shear rates, collisions with the pore walls reflected the particle back into the bulk and avoid capture. It was noteworthy that the Sherwood number was not zero even for a rod shaped particle of length three times the pore radius β₀=1.5). This may be explained by the fact that rod shaped particles, being slender, could enter the pore along their principal axis irrespective of the length. Similar to spherical particles, even a mildly strong suction flow (Q=1) drove a significant flux for all particle lengths (FIG. 10b) and the linear profiles associated with the 2QP term in (27).

FIGS. 10a and 10b.

The Sherwood number predicted by BD is plotted vs the Péclet number for various sizes of rod shaped particles.

Disk Shaped Particles.

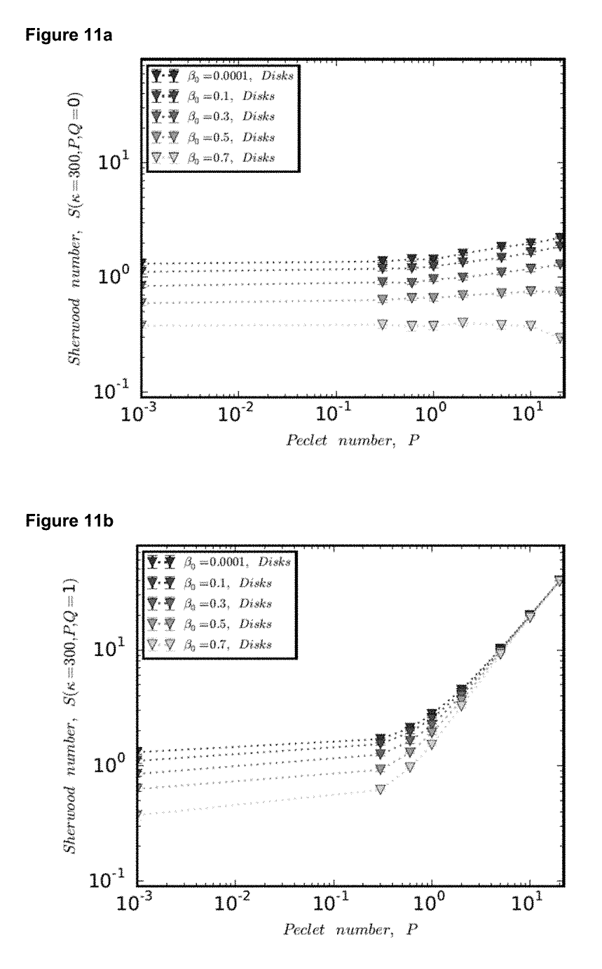

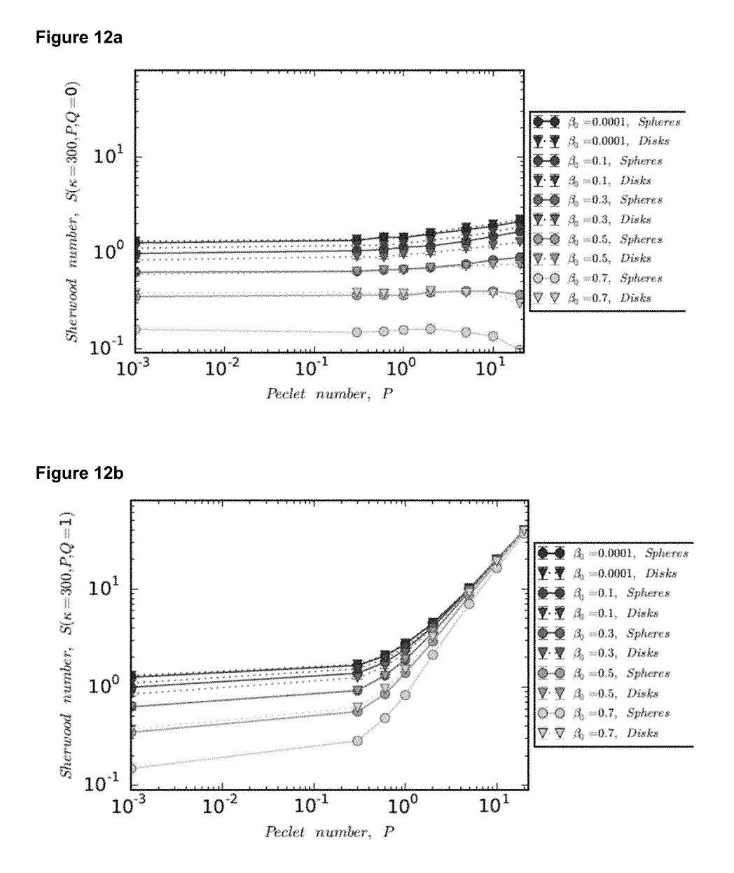

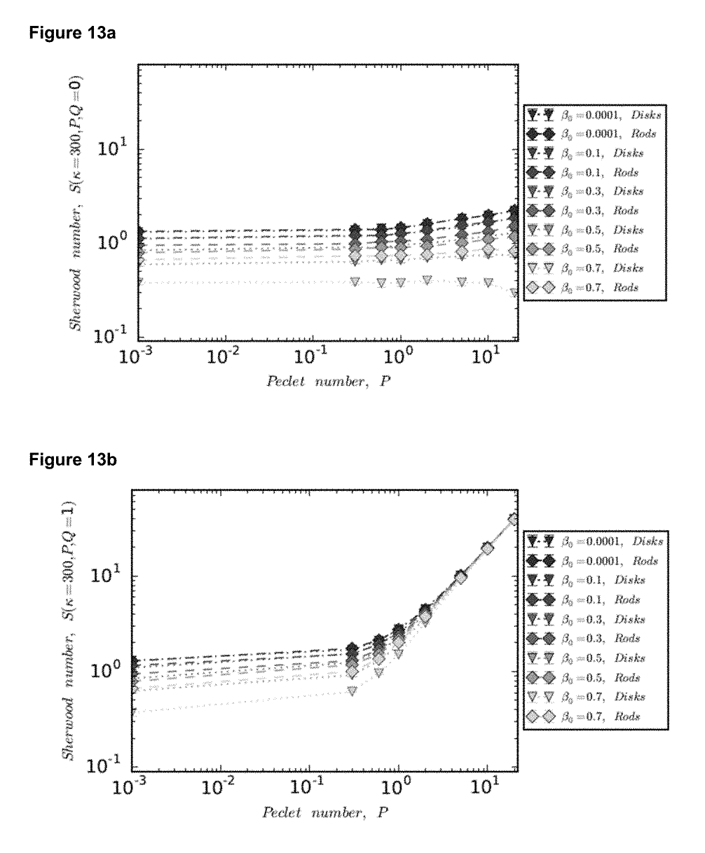

The flux data for disk shaped particles is shown in FIGS. 11a and 11b, where the case β₀=0.0001 again corresponded approximately to the point particle limit. The extravasation rate of disk shaped particles was qualitatively similar to the case of spherical and rod shaped particles as evident from FIG. 11a (Q=0) and FIG. 11b) (Q=1). Despite these qualitative similarities, there were import important differences in the extravasation ability of the different NPs of the same size (maximal dimension). These differences arose from the fact that rod shaped particles had a significantly smaller radial thickness compared to spherical particles of same maximal dimension. Disk-like particles were flatter and thus passed through a larger effective cross-section of the pore as compared to spherical particles. Thus it was not obvious what particle shape and size resulted in large extravasation rates. These differences are highlighted in FIGS. 12a, 12b, 13a and 13b by superposing the flux simulation data for comparable particle sizes.

FIGS. 11a and 11b.

The Sherwood number predicted by BD is plotted vs the Péclet number for various sizes of disk shaped particles.

2. Effect of Aspect Ratio and Interaction with Suction Flow

The three particle types were compared in the presence of simple shear flow. From FIG. 12a, it could be seen that disks had a greater flux than spheres of same size. Similarly, FIG. 13a shows that rods had a greater extravasation rate as compared to disks of the same size. As expected, the Sherwood numbers equaled each other (within standard deviation errors) in the limiting case of zero size of each particle. Then in general, for particles of comparable size, elongate particles were better suited for extravasation than flattened particles. Both geometries were better choices for particle shape compared to spherical particles.

This disparity in extravasation rates of similarly sized particles was noticeable upon imposition of a suction flow. Referring to FIGS. 12b and 13b, it was noticed that rod shaped particles of all lengths showed approximately the same (linear) growth rate in the flux as a function of Péclet number (at P>1). In comparison, disks and spheres demonstrated a visibly size dependent growth with the Péclet number. The basis for this phenomenon was the entanglement of rod shaped particles with the capture tube (from Example 1). The trapped rods aligned with the streamlines and pass through the pore ‘head-first’, almost irrespective of their sizes. In contrast, trapped spherical and disk shaped particles may have only fit through a large cross-section and collisions with the surrounding wall may have forced them out of the capture tube.

FIGS. 12a and 12b.

The Sherwood number predicted by BD is plotted vs the Péclet number for comparable sizes of disks and spheres.

FIGS. 13a and 13b.

The Sherwood number predicted by BD is plotted vs the Péclet number for comparable sizes of rods and disks.

Imposing a suction flow of strength Q=1 highlighted the physics of rod shaped particle transport. Referring to FIG. 10b, it can be seen that as the Péclet number (and thus, the suction Péclet number P_{Q}) increased, rod particles as long as the pore diameter β₀˜1) were eventually driven through the pore at the same rate as shorter particles. In contrast, longer rod particles (β₀=1.5) had a smaller flux because the rotational diffusion time scale 1/d^{r} was comparable to the suction rate time scale 1=(Q\dot{γ}) and there was competition between steric hindrance due to rotational diffusion and convection via suction, i.e., the rotation and suction based Péclet number P_{Qr} was ˜O(1) (recall (30e)). As suction strength increased, P_{Q} became larger and suction overcame rotational diffusion, leading to the linear growth in flux observed at large P_{Q} (see FIG. 10b). In contrast, as discussed before, spherical particles behaved quite differently in the presence of suction flow.

### Example 3: Comparison of Dimensional Extravasation Rates

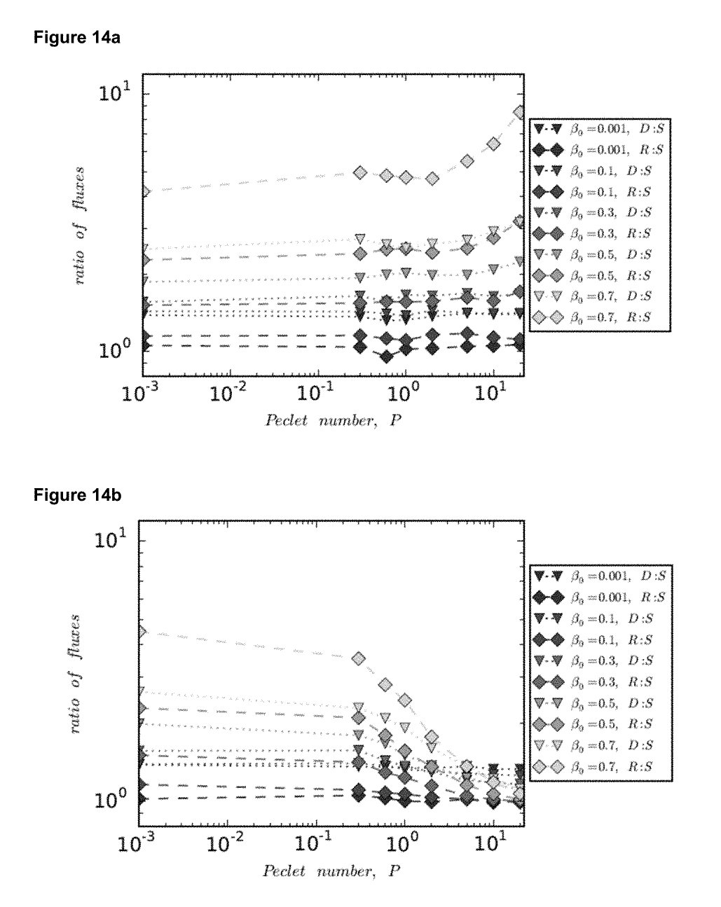

The actual dimensional extravasation rates of the two particles were compared. Recall that the actual extravasation rate is a dimensional flux that related to the Sherwood number via eq. (1f). Then, given the same tumor and flow conditions (in the dimensionless sense) the actual extravasation rate for NPs of same size but different shapes could be quite different. To demonstrate this, the ratio of the dimensional fluxes for two particle shapes at a time (rods:spheres and disks:spheres) was plotted. This was equal to the ratio of the respective Sherwood numbers multiplied by the ratio of the orientation-averaged diffusivity. From FIG. 14a, it can be seen that in the absence of a pressure gradient, perhaps the rod-like NP was consistently better suited for extravasation in all flow conditions. However, in the presence of a pressure gradient across the pore (Q=1), it can be seen from FIG. 14b that under strong flow conditions, the disk-like NP had a greater dimensional flux than the rod-like particle. Depending on the flow strength, BD simulations may support using one kind of particle over the other, and potentially save time and money.

FIGS. 14a and 14b.

The dimensional flux ratios of rods:sphere and disks:spheres predicted by BD is plotted vs the Péclet number for comparable sizes of each particle.

Thus, particle shape and size both had a significant effect on extravasation rate of NPs, suggesting that there may be a preferential uptake of particles of special geometries, depending on the tumor pore geometry and tumor specific flow conditions.

### Example 4: Comparison of BD Simulation Results with In Vitro Experiments

### Experimental Methods

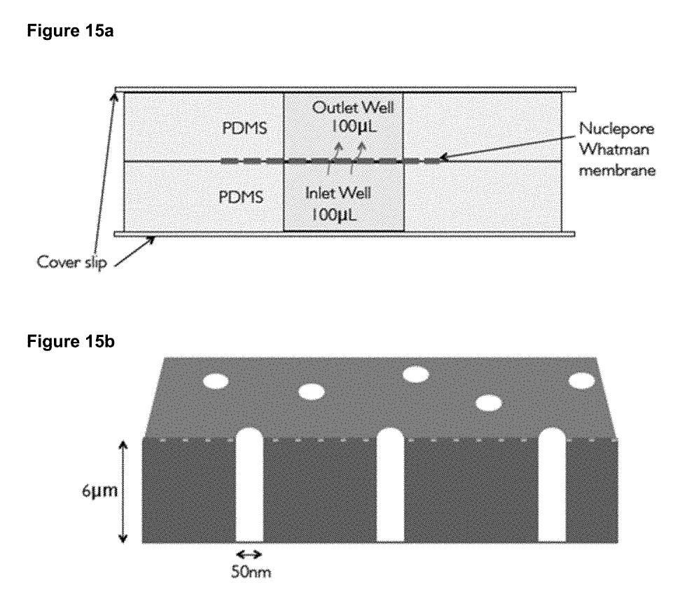

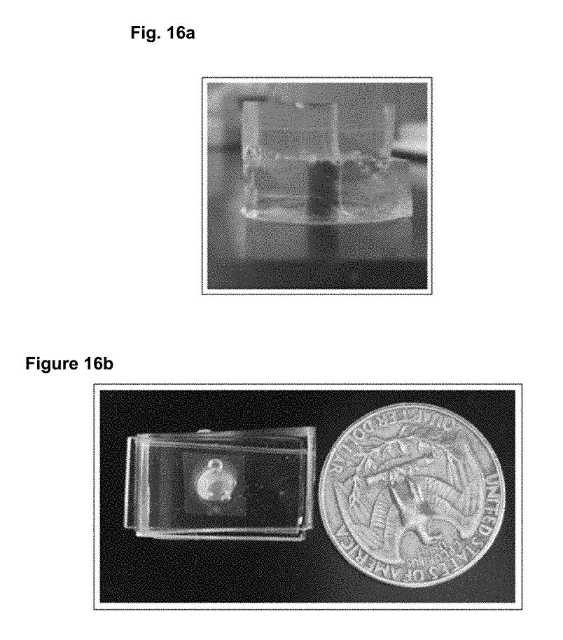

Devices composed of two PDMS layers with a thin porous membrane cut-outs in between were fabricated (FIG. 15a). These layers had cavities of volume Vₒᵤₜ=Vᵢₙ˜100 μL made using a Harris Uni-Core 5.0 punch. The layers were bonded on a common face while ensuring vertical alignment of cavities. The common face was cleaned for bonding using a Plasma Prep-III. The membrane was suspended over the lower PDMS layer prior to bonding so that it was sandwiched between the two layers after bonding. The common contact surface area of the cavities was A˜19.3e−6 m². A GE Whatman Nuclepore track-etched poly-carbonate membranes of pore radius a=50 nm (dia.), thickness 6 μm and pore density ρ˜6e+8 pores/cm² were used (FIG. 15b). These membranes are commercially available in a wide range of relatively monodisperse sizes, thicknesses and pore densities. The remaining assembly was delicate as the device was completed only after introducing solutions in each of the chamber cavities. NP solution in phosphate buffer saline (PBS) was first introduced to the lower ‘inlet’ chamber and a cover-slip applied to seal the cavity (FIG. 16a). Then pure PBS was introduced into the ‘outlet’ chamber and the chamber was sealed with cover-slips. This finished the assembly of the device (FIG. 16b) and corresponded to time t=0 of the experiment. Prior to introducing solutions in either chamber, the exposed surfaces of the partially assembled device was irradiated with UV light (for 3 min) which made the cover-slip stick easily. As the membrane was hydrophillic, the surfaces and the pores were automatically wetted at the start of the experiment. The cover-slip seals could be mechanically removed while taking samples for measurements.

FIGS. 15a and 15b.

(FIG. 15a) Schematic side view of the experimental device. (FIG. 15b) Schematic of the membrane.

FIGS. 16a and 16b.

(FIG. 16a) Side view of the device filled with NP solution in the inlet chamber. (FIG. 16b) The completed device setup viewed from above.

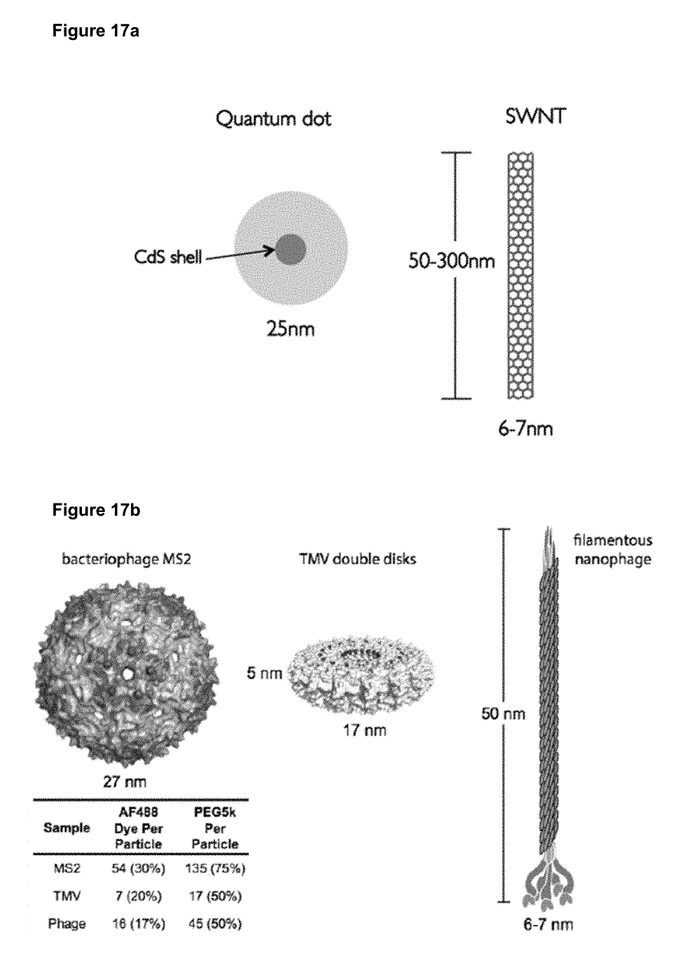

The NPs chosen for study could all be modeled by spheroidal geometry: (1) Quantum dots (QDOTs) of hydrodynamic diameter ˜25 nm, (2) Single Walled Nanotubes (SWNTs) that were 2-3 nm thin and 50 nm to 300 nm long (mean length 200 nm), (2) bacteriophage (MS2) of diameter 27 nm, (4) nanophage (NPG) that were 6-8 nm thin and 50 nm long, and (5) TMV virus of size 5 nm˜17 nm (FIGS. 17a and 17b). QDOTs were auto-fluorescent (emission peak˜800 nm) while SWNTs were loaded with cy5.5 NHS-Ester dye (emission peak˜694 nm). The remaining particles were organic protein based and tagged with Alexa Fluor 488 dye (emission peak˜519 nm). The procedure was to take aliquots from the outlet chamber and conduct fluorometry analysis on the sample upon appropriate dilution. These particles were initially prepared in PBS with concentrations of 5-10 μM. The NP solution were introduced at a 10-fold lower concentration (Cᵢₙ) so that the experiment was done in the linear regime of the fluorometer (Horiba FluoroLog-3).

During the initial development of the device, aliquots of 5 uL volume were taken from the outlet chamber at different time points over a duration of 24 h. This led to a significant reduction in the outlet chamber volume at the end of the experiment and required correction factors in subsequent data analysis. As only the average rate of concentration accumulation was required, the following protocol was used: a single aliquot of 10 μL volume was taken at the 24 h mark (or any suitably long duration). Then the single aliquot was diluted 6× (using 50 μL quartz cuvettes) and the fluorescence intensity was measured using the fluorometer. Then the concentrations (Cₒᵤₜ) from calibration curves prepared beforehand was read off. An advantage of using this device and protocol is that we could recover the NP solution at the end of the experiment.

It should be noted that as the particles were of known sizes (FIGS. 17a and 17b), their diffusivities could be modeled using (6.1a) from the BD algorithm. In the orientation averaged sense, the particle diffusivities were ˜10⁻¹¹ m²/s, which was confirmed by Dynamic Light Scattering measurements (Brookhaven Instrument 90).

### Results

dCₒᵤₜ/dt was calculated by dividing the aliquot concentration by time. Then to extract the Sherwood number S, this rate of concentration accumulation was converted into a dimensionless quantity using the formula:

$$\frac{{dC}_{out}}{dt} \frac{{V}_{out}}{ρπ {a}^{2} A} = \frac{{DC}_{in} S}{a} \qquad ( 6.4 )$$

It is noted that for time t>>L²/D·1 min where L=6 μm is the thickness of the membrane (and thus the depth of each pore), the membrane pores appeared to be at the same particle concentration as the inlet chamber. As a result, particles now diffused from the exit of the pores into the outlet chamber. This process was the reverse of the standard BD setup of Example 2. As such, the flux of such a process could be easily verified to be the same as in the standard setup, as the algorithm was time and boundary condition reversible. Then the Sherwood number calculated in the reverse case was expected to match the Sherwood number for the standard setup, except for the distinction that now the flux was into the periodic simulation box. As our experiments ranged over hours, the pore length was essentially not relevant by the above argument. Table 6.2 (FIG. 26) shows the Sherwood numbers for the different NPs considered here. The experimental values reported were means over 3 devices.

FIG. 26.

Table 2: Comparison of the experimental and BD fluxes for different NPs.

The error bars suggested that the experimental setup could be significant sources of errors, which essentially captured device to device variation (e.g., inexact overlap of outlet and inlet chamber). It is also noted that the calibration curves were generated on a log-scale as standard practice. Carrying out the fit to the calibration data on a log-scale contributed to large errors in Cₒᵤₜ on the normal-scale. Dynamic Light Scattering (DLS) experiments of these particles revealed that the particles were not mono-disperse and demonstrated a spread around a mean value close to their maximum dimensions (DLS cannot resolve aspect ratio). As such the small size population of NPs would have contributed more to the overall Sherwood number. In fact SWNTs are known to be polydisperse with lengths ranging from 50˜300 nm, and mean length of ˜200 nm. For such rod-like particles, the maximum dimensionless size β₀ took values between 1 and 4 for 50 nm pores. Recall from FIG. 10a that for particles significantly larger than the pore had a highly reduced flux. Then the experimental Sherwood number for SWNTs was greater than the BD one as they perhaps corresponded to different sized particles. Similarly, the discrepancy between the experimental and the BD result for MS2 may be attributed to the presence of free dye. However, it may be noted that both the experimental and the BD results across the different particles (except MS2) had the same ordering. This suggested that our BD simulations could predict the Sherwood number within reasonable error. More impressively, it could also distinguish between the particles based on shape and size by demonstrating the correct order relations between most of the particle fluxes.

While the present disclosure has been described with reference to the specific embodiments thereof, it should be understood by those skilled in the art that various changes may be made and equivalents may be substituted without departing from the true spirit and scope of the present disclosure. In addition, many modifications may be made to adapt a particular situation, material, composition of matter, process, process step or steps, to the objective, spirit and scope of the present disclosure. All such modifications are intended to be within the scope of the claims appended hereto.

1. A method of estimating the flux of spheroidal particles through a pore, comprising:
i) obtaining a set of input values for a Brownian dynamics (BD) particle flux simulator configured to simulate an environment comprising:
a vessel comprising (i) a medium and (ii) a boundary surface comprising a pore; and
a plurality of spheroidal particles in the medium,
wherein the input values comprise a plurality of dimensionless parameters comprising:
geometric parameters representing (A) an axisymmetric radius, r, of an individual spheroidal particle of the plurality of spheroidal particles, and (B) a principal semi-length, t, of the individual spheroidal particle; and
functional parameters representing (C) a shear rate, \dot{γ}, of the medium, and (D) an adsorption rate, k, of the individual spheroidal particle for the pore,
wherein the geometric and functional parameters are rendered dimensionless by (1) a time scale of an orientation-averaged diffusivity, D, of the spheroidal particles, and/or (2) a length scale of a radius, a, of the pore;
ii) simulating a stochastic motion of the plurality of spheroidal particles in the environment based on the input values using the BD particle flux simulator, to generate a simulated value of flux of spheroidal particles through the pore; and
iii) calculating a dimensionless measure of the flux of spheroidal particles from the vessel, based on the simulated value of flux.

2. The method of claim 1, wherein the particle is a nanoparticle.

3. The method of claim 1, wherein the dimensionless parameter for the axisymmetric radius, α=r/a.

4. The method of claim 1, wherein the dimensionless parameter for the axisymmetric radius, β=t/a.

5. The method of claim 1, wherein the dimensionless parameter for the shear rate,
$$P = \frac{\dot{γ} {a}^{2}}{D} .$$

6. The method of claim 1, wherein the dimensionless parameter for the adsorption rate,
$$κ = \frac{ka}{D} .$$

7. The method of claim 1, wherein the input values further comprise values for dimensionless parameters based on a pressure difference, Δp, across the pore.

8. The method of claim 7, wherein the dimensionless parameter for the pressure difference across the pore,
$$Q = \frac{Δ p}{6 πμ \dot{γ}} ,$$
where, μ is the viscosity of the medium.

9. The method of claim 1, wherein the input values comprise a porosity of the porous surface.

10. The method of claim 1, wherein the simulating comprises using a time step of 0.001 or less.

11. The method of claim 1, wherein the plurality of spheroidal particles comprises 10,000 or more particles.

12. The method of claim 1, further comprising iterating a)-c) with different sets of input values for a plurality of times, wherein a set of input values used for an iteration is based on the flux estimated from one or more previous iterations.

13. The method of claim 12, wherein the simulated environment is a simulation of a blood vessel adjacent a tissue.

14. The method of claim 13, wherein the tissue is a pathological tissue.

15. The method of claim 14, wherein the pathological tissue is tumor tissue.

16. A method of producing a particle, comprising:
i) defining two or more different sets of values of geometric parameters for a particle, wherein the geometric parameters comprise:
an axisymmetric radius (r) of the particle; and
a principal semi-length (t) of the particle;
ii) for each of the two or more different sets of values of geometric parameters, estimating the flux of a particle from a vessel comprising a medium, and a boundary surface comprising a pore, using the method of claim 1;
iii) producing a particle having a set of geometric parameter values selected from the two or more different sets of values of geometric parameters based on the estimated flux.

17. A system comprising one or more processors; and a non-transient, computer-readable medium comprising one or more programs, the one or more programs comprising instructions that, when executed by one or more processors of a computer system, causes the one or more processors to perform a method according to claim 1.
